(19) United States
(12) Patent Application Publication
(10) Pub. No.: US 2017/0365239 A1
(43) Pub. Date: Dec. 21, 2017

(54) PRACTICAL SOLUTION TO THE PROBLEM OF TENSION EQUALIZATION IN WIRE TENSIONED AROUND DRUMS AND OBJECTS, WIRE END SECURING KNOTS AND DEVICES, AND THE PROTRACTED TIME IN WIRE REPLACEMENT AND TENSIONING.

(71) Applicant: David A. Peterson, La Paz (MX)

(72) Inventor: David A. Peterson, La Paz (MX)

(21) Appl. No.: 15/185,711

(22) Filed: Jun. 17, 2016

(51) Int. Cl. G10D 3/14

(52) U.S. Cl. CPC G10D 3/14

(57) ABSTRACT

A practical solution to the problem of tension equalization in wire tensioned around drums and objects, wire end securing devices, and the protracted wire replacement and tensioning time. In some embodiments, jaws in cooperating chambers replace securing knots, which eliminates a sources of tension equalization, the protracted time in tying the knot, and thus permits rapid wire installation and automatic wire clamping. Some embodiments use linear translation via pistons to replace take-up drums, thereby eliminating another source of tension equalization. Other embodiments increase tension equalization by reducing the length of wire wrapped around drums or bridge tie-blocks. Yet other embodiments utilize drums having surfaces which reduce or increase tension equalization. Wire quick release mechanisms, rapid manual course tensioning, and compatibility with automated tensioning tools, address the protracted time in wire replacement and tensioning.

### STRING OVERVIEW

All stringed musical instruments require tuning at string replacement, and then continually, in part, due to changes in physical conditions to which an instrument is subjected to. These include ambient air temperature and humidity, heat radiated by musicians contacting their instruments, and external sources such as stage lighting and air-conditioning. Humidity and temperature change causes a musical instrument to expand and contract, thereby shortening or lengthening the vibrating length of the string, resulting in a change in pitch and therefore re-tuning.

String properties also affect the stability of musical pitch. Music wire and nylon cord (polyamide) are the two types of materials most used today; gut having been replaced by nylon in the late 1940's. Strings are either plain or wound. Wound strings are made with a core of music wire or a plurality of nylon filaments. Solid string cores may be round or hex, and are wound under tension with a variety of metal wires including silver plated copper, phosphor-bronze and brass.

Strings are visco-elastic and have the following properties. Elasticity is the ability of a string to resist tension and to return to its original size and shape after applied tension is removed. Creep is the tendency of a string to continuously stretch while under constant tension. Stress relaxation is the permanent deformation in length and diameter of a string under constant tension. Visco-elasticity is more pronounced in nylon strings, and it is presumed to be more prevalent in plain strings than wound strings (nylon and steel).

In summation, strings are elastic, lose tension (creep) and deform (stress relaxation). With the onset of constant tension (primary stage,) creep rate is high and decreases rapidly with time, it then enters a steady state (secondary stage) where creep is even and low and then is followed by a rapid increase in creep, and finally, fracture (tertiary stage).

### BACKGROUND—PRIOR ART

A portion of the disclosure of this patent document contains material which is subject to protection. The copyright owner has no objection to the facsimile reproduction by anyone of the patent document or the patent disclosure, as it appears in the Patent and Trademark Office patent file or records, but otherwise reserves all copyright rights whatsoever.

### String Stretch

String stretch is a term musicians use when confronting the initial repetitive loss of pitch with newly replaced strings. After a new string is tuned to a musical note, the pitch immediately lowers. To expediate the time it takes for a string to hold a note, a string is pulled by hand from its mid-section over the body of the instrument and then re-tuned. The instrument is strummed vigorously and then re-tuned. These techniques are alternated and repeated many times until the string stretch is less pronounced. The instrument will then require regular re-tunings. String pulling is time consuming. String stretch may last for a day to several months depending on the hours of play and number of re-tunings. String pulling may exceed the designed operating tension of the instrument's bridge and may put certain instruments at risk to bridge/top joint failure.

### Tension Equalization

Visco-elastic properties of strings partially address the string stretch musicians refer to, but the copious quantity of string stretch goes well beyond the published creep curves for constant loads, creep curves with recovery, and creep curves for linear visco-elasticity, nor does it address plain strings stretching more than wound strings, and nor does it address why vigorous strumming causes a lowering of pitch.

### Drums

In one system, an end of a string is secured without slippage to a tensioning drum, and the other end is secured without slippage to an anchor. As the drum is rotated, slack in the string wraps around the drum without tension. Assuming no slippage between the string and the drum, the tension on the string increases with the rotation of the drum. The string at every point of contact with the drum is at a different tension. In practice, there is some slippage between the string and the drum. The string physically moves on the drum as the initial lower tensioned string wraps equalize with the latter higher tensioned wraps, thereby resulting in an overall reduction in tension of the vibrating portion of the string. This is an example of tension equalization. In summation, tensioning a string around a drum introduces tension equalization with a resultant loss of stable tune.

### Knots and Anchors

In another system, a string is secured to an anchor by a knot. As tension is applied, the string physically moves within the knot until the string to string and string to anchor friction equals the applied tension. Tension increase and creep, cause the diameter of the string to decrease, thereby reducing friction. The distance between two sources of friction within a knot is called a section. As tension is increased in the section of string entering the knot, it overcomes friction and slips. This causes its energy or tension to be transferred to the next section of string within the knot, resulting in a cascade effect. This is another example of tension equalization. In summation, knots and anchors introduce tension equalization and a resultant loss of stable tune.

### String Length

The total string length consumed, in a securing knot about an anchor or in wraps around a drum, has an effect on tension equalization. As a section of string equalizes within a knot or around a drum, its energy or tension is transferred to the next section of string. The length of the next section is of importance because the energy is distributed along that length of string. The shorter that section is, the higher the resultant concentration of energy (tension). Short sections equalize at a faster rate. In summation, knots, anchors, and drums should consume as little string length as possible to speed the process of tension equalization and the arrival of stable string tension and tune.

### Friction Reduction

Wound strings in contact with a smooth surface, have a reduced contact surface patch due to their profile than do like diameter plain strings. This reduction in surface area reduces the friction between the string and the surface, thereby increasing the rate of tension equalization. This answers the question of why wound string ‘stretch’ less than plain strings.

Vibration from strings under tension or other sources, reduces string contact pressure intermittently, thereby reducing friction and therefore encouraging an increased rate in tension equalization. This explains why aggressive strumming is used by musicians to expediate the time it takes for a string to hold a note.

Haphazard lubrication of frictional surfaces by human sweat and oils, waxes, polishes and natural wood oils, injects another variable to the frictional component of tension equalization. Factors that reduce friction, increase tension equalization. In summation, a) increase in friction reduces the rate of tension equalization, b) decrease in friction increases the rate of tension equalization c) friction is a fundamental component of tension equalization.

### Conclusion

Tension equalization is a factor in initial and continual repetitive loss of wire tension in machinery, apparatus, and stringed musical instruments. Visco-elastic properties of wires and strings are a lessor factor in the aforementioned equation.

Tension equalization occurs randomly throughout an instrument's string path, and results in a loss of relative tuning between the strings. Tension equalization interferes with vibrato devices, string bending, finger vibrato, vigorous strumming, flamenco golpe (tapping) and slapping, and loss of relative pitch after temperature and humidity change. A solution to the problem of tension equalization will improve the stability of tensioning methods and the playability of stringed musical instruments.

### Down Force

FIG. 16B may be referenced for the overall shape of a traditional bridge. FIG. 17A depicts a traditional bridge and saddle in cross-section which will be under discussion. The down force arrow 423, represents the position of the direct string path from saddle to string hole entry 417 into the tie-block 407b. The saddle is physically coupled to the bridge which is physically coupled to the top or sound board. Vibrational energy of the strings is transferred through this coupling to the sound board, thereby exciting air molecules which are perceived as sound. The greater the angle of the string, bending over the saddle, the larger the saddle down force and the resulting volume of the instrument. In summary, the greater the saddle down force, the greater the volume and efficiency of the instrument.

### PriorArt Discussion

Lowe U.S. Pat. No. 3,830,132, offers a tuner without drum tuning, utilizing a linear piston to tension the string. The string is secured by a drum with a slot to retain the string end. The string is positioned in this slot and wrapped around the drum, thereby introducing a source of unwanted tension equalization. The string end running out of the slot is fatigued by bending back and forth until separated. This is not a prudent method of cutting a string and there is some chance of injuring one's self. The string attachment and cutting is time consuming. The string transition into the tuner is over an outwardly projected shoulder, which adds a frictional component which introduces tension equalization. The total length of piston travel appears to be insufficient to tune all string types to concert pitch, and the problem is compounded by tension equalization at the drum.

Caruth U.S. Pat. No. 4,674,387, offers a linear tuner utilizing a 2:1 pulley system which requires twice the piston travel, twice the string length, twice the button rotations and twice the time. The resultant embodiments are large and ungainly. The string securing method range from a lever mechanism, that could be accidently knocked and released, to a series of clamping screw systems which requires a screw driver. Strings can fracture when clamped by a rotating body. One embodiment, having an undersized thumb screw, requires the string to be wrapped around a drum, cut off with a tool, and then held by hand to prevent the string from unwinding while the thumb screw is tightened. Holding a sharp cut wire by finger and/or thumb while tightening a thumb screw down onto them is not practical and is time consuming.

Steinberger U.S. Pat. No. 5,103,708, has a linear tuner with a short piston travel. Insufficient piston excursion experienced while tuning, requires complete tension release and re-clamping of the string end while it is under tension. This is difficult and usually requires pliers to grip and pull the short string end before re-clamping. The string is then re-tuned to pitch. The aforementioned exercise is frustrating and time consuming. The string clamp knob requires a pair of pliers in practice or other tool to tighten appropriately. The flange portion includes a bearing surface for transitioning the string into the tuner, which induces tension equalization and tuning problems. A 40:1 tuning ratio requires more than twice the button rotations and twice the time to tension a string to pitch.

Smith U.S. Pat. No. 1,498,487, Frederick U.S. Pat. No. 4,528,887, and Gonzalez U.S. Pat. No. 8,952,231, have tuners with ratchet assemblies offering a 1:1 course tuning method. The drawback of these designs is the use of drums for string take up with no means to compensate for tension equalization. Smith and Frederick have no string affixing means to rid the designs of one or more knots. Frederick's design is also complex and expensive to manufacture. Gonzales course tuning system requires separate tools for clamping a string and setting course tension. Course tension has to be held manually with a tool while another tool tightens the set screw. Smith's embodiment has a small diameter course tensioning knob which will be difficult for most users and impossible for some to rotate while under tension. Frederick's embodiment has a larger course tuning knob that may aid in its rotation, but will be difficult for most. Smith's and Frederick's design's are overly large due to the ratchet and pawl assembly being external of the gear train.

FIG. 9A depicts a traditional and ubiquitous prior art tuner that has been installed on millions of instruments. Installation requires two different diameter holes to be bored in the headstock. The headstock is sandwiched between the body of the tuner and a thrust washer which is secured with a nut. The drum has a hole to receive a string end to be tied with a knot, thereby introducing tension equalization in two areas, the knot and the drum.

FIG. 11A depicts a traditional and ubiquitous prior art classical guitar tuner that also has been installed on millions of classical and flamenco guitars. The worm and worm gear are exposed in this design. The tuner mechanism is installed on a plate having standardized spacing. The tuner assembly is large and heavy, and requires a large, heavy and complex headstock, with resultant extensive fabrication. A lighter headstock exerts less weight on the fingering hand of some musicians. The drum has a hole to receive a string end which is tied with a knot, thereby introducing tension equalization in two areas, the knot and the drum.

FIG. 17A is a prior art cross-section of a traditional and ubiquitous bridge design installed on millions of classical and flamenco guitars. The string path includes 9 locations where tension equalization is introduced. The areas specifically are, over the bridge 416, string hole entry 417, string hole exit 418, over clamped string end 422, transition to top of tie-block 419, off tie block 420, around down force string 421, back on to tie block 420, and finally, transition to the clamping surface 419. A disadvantage of this old design is the multiple points of induced tension equalization. Another disadvantage is the reduction of saddle down force caused by the string wrapping around the down force string 421, thereby reducing the angle of the down force string. The excessive string length behind the saddle to the affixed string end, initiates long term tension equalization. The above mentioned disadvantages result in tuning problems.

Gunn U.S. Pat. No. 4,872,388, has an end-stock termination (headless) with a string clamping and cutting device utilizing screw clamps or off-center lever clamps with built in string cutters. The screw clamps will likely need pliers to tighten them appropriately. The clamping arm requires an adjustable screw to be set by a tool to ensure adequate clamping pressure for each string gauge. In practice this arrangement will be troublesome, as the string may skirt off the limited surface area of the set screw while being clamped. Kang U.S. Pat. No. 6,172,287, addresses clamping with a slit drum having a small diameter knob which will probably require pliers. Drum tensioning introduces tension equalization problems. The designs of both Gunn and Kang do not permit a luthiers' artistic license to be expressed in the most prized position on an instrument. The instrument neck termination must be of predetermined shape and size to accommodate their designs.

Rochester US Patent 2015/0000501, has a spring lock terminal post as is used on inexpensive speaker terminals. The cap will require one hand to push the button down to align the four string holes without benefit of visual aid, while the other hand inserts the string into the four holes. Required spring tension may also have a tendency to fracture some strings.

McCane U.S. Pat. No. 5,696,341, has developed a crank to aid turning the buttons, which requires replacing existing buttons with crank cooperating buttons. A multitude of different button styles, shapes, materials, colors and affixing means would be required to implement McCane's idea. Musicians may have reservations concerning modification to their instruments. Paul U.S. Pat. No. 3,813,983, has a motorized version of a speed winder. The device is more trouble, than the problem, it proposes to solve. Oudshoorn et al. U.S. Pat. No. 6,437,226 has is an automatic tuning device that is installed on new instruments or is retro-fitted to existing instruments. The design is electronic and mechanical and adds a layer of complexity to non-complex instruments. Acoustic instruments are probably not candidates for this device.

### Disadvantages of Prior Art

To present all the tuners, and end securing means heretofore known suffer from one or more of the following disadvantages:
a) Linear designs have limited piston travel which may not attain required tension. This problem requires full tension release, re-clamping the end of the string while it is placed under tension, and re-tuning to pitch. This problem is severe, being frustrating and very time consuming.
b) Linear designs may require strings to be reinstalled after creep or deformation. This problem requires full tension release, re-clamping the string end while it is placed under tension, and re-tuning to pitch. Again, this is serious problem.
c) Some linear designs have a bearing surface for transitioning the string into the tuner which introduces tension equalization.
d) Linear designs having ratios up to 40:1 require more than twice the rotations of the button to tune, more than twice the time, and add string length which retards tension equalization.
e) Many worm/worm gear tuners require two different diameter holes to be bored in the headstock for mounting, as well as a screw hole to stop rotational forces exerted by the string under tension.
f) Worm/worm gear tuners use drums and string affixing knots which introduce tension equalization.
g) Worm/worm gear tuners have back lash in the gears which require tuning from below the note.
h) Classical guitar tuner assemblies are large and heavy and they require a large, complex, and heavy headstock, requiring extensive fabrication.
i) String clamping methods on many tuners, require the use of pliers or other tools in practice to enable slip free performance, which may also lead to string fracture.
j) String clamps utilizing screws may lead to string fracture when applied rotational forces are not addressed.
k) Some prior art tuners possessing course tuning capability, have ungainly external ratchet and pawl assemblies. The typically undersized knobs are difficult or impossible to rotate by hand and may require the use of a pair of pliers. Some require a screw driver to course tune.
l) Traditional classical and flamenco guitar bridge designs suffer from introducing tension equalization and have limited saddle down force.
m) Headless termination devices add weight and require an instrument's end-stock to be of predetermined shape and size.
n) End-stock devices eliminate the headstock, the most prized position for a luthier to take artistic license in his or her marque.
o) Built in electro/mechanical tuning requires permanent alteration to an instrument. The design adds a layer of complexity to non-complex instruments. Tuning function is available only when plugged in and powered.
p) Speed winders, manual and automatic, suffer from being an accessory. Some require an electrical source, and all are required to be with the instrument when needed.

### SUMMARY OF SOME EMBODIMENTS

In the pursuit of a practical solution to the problem of tension equalization in wire tensioned around drums and objects, knots and wire end securing devices, and the protracted time required in wire removal, replacement and tensioning, many embodiments have been developed. What follows is a summary of a few of those embodiments related to musical instruments, and more specifically guitars. The following descriptions are not intended to represent the only configurations in which the concepts and features described herein may be practiced. The following descriptions includes specific details for the purpose of providing a thorough understanding of various concepts. However, it will be apparent to those skilled in the art that these concepts may be practiced without these specific details.

### Linear Tuner

In accordance with one embodiment, a linear tuner has a cylindrical body comprising a capstan having a selector knob that opens and closes a pair of cylinder jaws via a release actuator. A low friction pulley transitions a string into the cylinder's axial opening therethrough. A piston with a forward pair of piston jaws is threadedly engaged to a button at the rearward end of the piston and external to the cylinder. The piston is slidably disposed in the cylinder.

A string is inserted from the top of the selector knob and extends beyond the end of the button. Rapid course tuning is engaged by rotating the selector knob 180 degrees to pull position. Pulling the button, pulling directly on the string end, or pulling via a tensioning device, tensions the string, and the cylinder jaws hold the resultant tension. To fine-tune, rotate the button to relieve the tension from the cylinder jaws, then place the selector knob back to home position. At string replacement time, a release position permits string removal and replacement to be accomplished in seconds.

A tuner having a traditional peg form permits classical and flamenco guitar headstocks to revert to the light weight peg head. The tuner rapidly installs in a single 8 mm hole in the peg head. Further, peg heads have in line of sight positioning of the buttons and a natural hand position during tuning.

In summation, a string can be rapidly inserted and automatically affixed, course tuned manually, course tuned by a tensioning device, and fine-tuned conventionally by rotating the button, while eliminating tension equalization derived from securing knots and drums, reducing the protracted time in string replacement, and having traditional dimension, mounting and appearance.

### Drum Tuner

In accordance with another embodiment, a tuner with a body of tradition appearance has a worm that cooperates with a removable button-driver which has an integral tuning socket driver. The driveshaft has a ratchet which is driven by a worm gear and an internal pawl drive. The driveshaft has a tuning socket on the driven end which cooperates with the tuning socket driver of the button-driver. The other end drives a disc drum having a plurality of freely rotating discs. An increase of tension equalization results from the reduced frictional component of the freely rotating independent discs, which encourage string sections to move and equalize.

An advantage of this embodiment is rapid course tuning and string clamping by using the button-driver. Due to the mechanical advantage afforded by the button and its ergonomic shape, rotating the drive shaft directly, or tightening the string clamp, is feasible and comfortable. Only one button-driver is required per tuner set, thereby lowering manufacturing costs. Also, the button-driver is always with the instrument when needed.

A tuner having an increase in tension equalization permits large excursions in string bending, vibrato technique, vibrato arm use, and with enhanced return to pitch. An instrument with increased tension equalization will maintain relative pitch to a much higher degree, even during temperature and humidity changes.

The tuner body has near exact dimensions permitting retro-fitting, without any modifications into existing instruments and installation into new factory production.

### Instrument Bridge

In accordance with another embodiment, a traditional musical instrument bridge is disposed with string gripping jaws that affix the string ends. String affixing jaws have negligible tension equalization, and the reduced string length behind the saddle speeds tension equalization over the saddle. The bridge has the ability to rapidly pre-tension or course tune a string manually or by a tensioning device. This is especially desirable if the instrument has prior art tuners having a knotted drum, and lacking course tuning capabilities. The new string path increases the down force on the saddle and a string can be quickly replaced in seconds. All this, and the aforementioned advantages, in a bridge of traditional appearance, construction and dimension.

### DESCRIPTION OF THE DRAWINGS

FIG. 1A is an isometric view of the first embodiment in retracted position.

FIG. 1B is cross-section of the first embodiment in retracted position.

FIG. 2A is an isometric view of the second embodiment in home position.

FIG. 2B is an isometric view of the second embodiment in pull position.

FIG. 3A is an exposed side view of the second embodiment in home position.

FIG. 3B is an exposed isometric view of the second embodiment in release position.

FIG. 3C is an exposed isometric view of the second embodiment in pull position.

FIG. 4A is an isometric view of the selector knob and release actuator of the second embodiment.

FIG. 4B is an isometric view of the capstan, pulley, axel, and set screw of the second embodiment.

FIG. 4C is an isometric view of the cylinder jaws, extension spring, and cylinder plunger of the second embodiment.

FIG. 5A is an isometric view of the cylinder 150ac of the second embodiment.

FIG. 5B is an isometric view enlargement of cylinder 150ac of the second embodiment.

FIG. 5C is an isometric view of piston plunger, plunger spring, and adjustable nut of the second embodiment.

FIG. 5D is an isometric view of the retainer installation tool.

FIG. 6A is an isometric of the adapter assembly.

FIG. 6B is an isometric view of an adapter.

FIG. 6C is an isometric view enlargement of an adapter.

FIG. 7A is a front view cross-section of the second embodiment in home position.

FIG. 7B is a side view cross-section of the second embodiment in home position.

FIG. 8A is a front view cross-section of retainer installation tool.

FIG. 8B is a side view of retainer installation tool.

FIG. 9A is an isometric view of prior art of the third embodiment.

FIG. 9B is an isometric view of the third embodiment with exploded button-driver.

FIG. 10A is an exploded isometric view of the third embodiment.

FIG. 10B is an exploded isometric view of the disc drum of the third embodiment.

FIG. 10C is an isometric view of a prior art worm of the third embodiment.

FIG. 11A is an isometric view of prior art of the forth embodiment.

FIG. 11B is an isometric view of the forth embodiment with button-driver.

FIG. 12A is an exploded isometric view of a prior art worm assembly of the forth embodiment.

FIG. 12B is an exploded isometric view of worm assembly of the forth embodiment.

FIG. 13A is an exploded isometric view of driveshaft assembly of the forth embodiment.

FIG. 13B is an exploded isometric view of driveshaft assembly of the forth embodiment.

FIG. 14A is an exploded disc drum of the forth embodiment.

FIG. 14B is an isometric view of string clamp of the forth embodiment.

FIG. 14C is an exploded isometric view of button-driver of the forth embodiment.

FIG. 15A is a side view cross-section of driveshaft of the forth embodiment.

FIG. 15B is an enlarged side view cross-section of driveshaft of the forth embodiment.

FIG. 16A is an isometric view of end-stock of the fifth embodiment.

FIG. 16B is an isometric view of bridge assembly of the fifth embodiment.

FIG. 16C is an enlarged isometric view of bridge assembly of the fifth embodiment.

FIG. 16D is an isometric view of pin bridge of the sixth embodiment.

FIG. 16E is an enlarged isometric view of the sixth embodiment.

FIG. 17A is a cross-section of a prior art classical guitar bridge.

FIG. 17B is cross-section of pin bridge of the sixth embodiment.

FIG. 17C is a cross-section of speed bridge of the fifth embodiment.

FIG. 18A is an isometric view of a Torre headstock with adapters.

FIG. 18B is an isometric view of a peg head.

### GLOSSARY

Bending a fretted stringed instrument playing technique of pushing a string across the fretboard to raise its pitch.
Bridge a part of the guitar body which terminates the vibrating length of the strings, and may also act as an anchor for string ends.
Button the ergonomic shaped part that is used to adjust string tension on a tuner; also known as a tuner, thumb screw, or tuning knob.
Course Tuning the process of tensioning a string up to the point where fine-tuning commences, or rapid course tuning by circumventing fine tuning means.
End-stock a stringed instrument without a conventional headstock or peg head, having in its place, string anchors, a string anchoring fixture, or a tunable string anchoring fixture.
Fine Tuning using the button with mechanical advantage to precisely tune the string to required pitch.
Headless see end-stock.
Headstock the part of a stringed musical instrument at the end of the neck to mount tuners.
Luthier one who makes stringed musical instruments.
Nut the vibrating string length's termination point that is mounted on the end-stock.
Peg head a type of headstock designed to mount open and closed gear tuners, peg tuners or friction pegs.
Pitch the frequency of a tone.
Pre-tensioning pulling a string taut by hand or other means before clamping or tying a string.
Relative Tune the musical pitch relationship between the strings of a musical instrument.
Saddle the vibrating string length's termination point that is mounted on the bridge.
String Path the routing of a string between string anchor points.
Tailpiece part of a stringed musical instrument that secures the ends of strings and may be secured to an instrument's top or be suspended between the bridge and the end of the body of the instrument.
Tensioning Device typically a cable tie puller having variable tension which accurately and automatically limits tension to a preset level which permits rapid course tuning without need to reference string pitch. May also be a slightly modified digital torque screwdriver which accurately and automatically limits tension to a preset level.
Tie-block part of a classical or flamenco bridge that is used as an anchor to tie and secure the string ends.
Torque Device typically a digital torque screwdriver that accurately and automatically limits torque to a preset level, permitting rapid course tuning without need to reference string pitch; used to course tune some embodiments.
Torres Headstock a type of headstock used to mount conventional classical tuners, assumed to be designed by Antonio de Torres de Jurado.
Vibrato a stringed instrument playing technique of changing the pitch up and down.
Vibrato Assembly a mechanical system, behind or part of a bridge, having an arm that permits a musician to add vibrato to all strings of the instrument simultaneously.

### DRAWING REFERENCE NUMERALS

98 string (not illustrated)
100 selector knob
100A selector knob—home position
100B selector knob—pull position
101 selector knob—skirt
102 capstan body
102a capstan body
103 pulley
104 pulley—string groove
105 pulley axel
106a pulley axel—threaded end
106b capstan—threaded hole
107a capstan—set screw
107b capstan—set screw recess
107c cylinder—centering hole
108a capstan—threaded shoulder
108b capstan—nut
108c capstan—thrust washer
108d cylinder—thrust washer
108e cylinder—nut
108f cylinder—threaded collar
108g adapter—recess
109 selector knob—split ring wire retainer
110a capstan—retainer groove
110b selector knob—retainer groove
111 selector knob—string hole
111a integral capstan—string hole
112 capstan—neck
113 selector knob—bevel
114 cam shaft
114a cam shaft—surface stop
114b release actuator—surface stop
115a selector knob—knob stop
115b capstan—knob stop
116a selector knob—knob stop
116b capstan—knob stop
117A cam shaft—cam surface
117B release actuator—cam surface
118 selector knob—string clearance slot
118b integral capstan—string clearance slot
119a release actuator
119b capstan—axial opening
119c release actuator—key
119d capstan—keyway
119e release actuator—string clearance slot
119f capstan—string clearance slot
119g release actuator—string hole
120 release stub
120a release stub—axial string hole
120A release actuator/stub—forward inclined outwardly radiating surface
120B jaw—forward inclined outwardly radiating surface
121 jaw
121-O jaw—open position
121-C jaw—closed position
121a jaw—offset inclined surface
121b jaw—flat surface
121c jaw—stop
121d jaw—trimmed surface
121e jaw—rearward surface
121f jaw—string gripping surface
122 chamber
122a chamber—offset inclined surface
122b chamber—flat surface
122c chamber—stop wall
122e chamber—stop wall edge
123b cylinder plunger—flat surface
124 cylinder plunger
125A jaw—rearward inclined outwardly radiating surface
125B cylinder plunger—rearward inclined outwardly radiating surface
125c cylinder—bevel
126a cylinder plunger-edge
126b cylinder—inside wall
125c cylinder—bevel
128 cylinder plunger—bevel
129a cylinder plunger—spring housing hole
129b cylinder—spring housing hole
129c cylinder plunger—drift pin hole
129d cylinder—drift pin hole
129e drift pin
130 cylinder plunger—string hole
131 cylinder plunger—barrel
132 piston plunger—string hole
132A cylinder plunger—forward inclined outwardly radiating surface
133 cylinder plunger spring
134 alignment spring
134a alignment spring—string hole
135 piston plunger
135B piston plunger—rearward inclined outwardly radiating surface
136a piston plunger—barrel
136b adjustable nut—internal thread
136c piston plunger—flat surface
136d piston plunger—edge
137a adjustable nut—external thread
137b piston—internal thread
138 adjustable nut
138a adjustable nut—slot
138b piston plunger—clip
138c piston—clip groove
139 piston plunger—spring
140a piston
140b piston
140c piston
141a piston—external thread
141b button—internal thread
142a piston—key
142b cylinder—keyway
142c cylinder—set screw
142d cylinder—threaded hole
143a piston—split ring wire retainer
143b piston—forward radial groove
143c cylinder—radial groove bevel
143d cylinder—rearward radial groove
144a button—split ring wire retainer
144b button—radial groove
144c piston—radial groove
144d piston—radial groove bevel
145 button
146a button—drive surface
146b cylinder—driven surface
147 expander tool
147a expander tool—barrel
147b expander tool—cone
148 stanchion tool
149a stanchion tool—base
149b stanchion tool—cylinder
149c stanchion tool—seat
150a cylinder/retainer/c collar
150b cylinder/screws/c collar
150c cylinder/no jaws/c collar
152a cylinder—flare
152b button flare
154 cylinder neck
155 cylinder—neck seat
155a cylinder—alignment tab
155b adapter—alignment slot
156a cylinder neck—external threads
156b capstan—rearward socket (not shown)
108g adapter—recess
157 adapter assembly
158a adapter—tuner hole
158b cylinder—adapter bevel
158c adapter—bevel
159a adapter—seat
159b adapter—seat slope
159c adapter—seat wall
160a adapter EE
160b adapter AB
160c adapter DG
161a adapter—stub
161b adapter—stub key
162a adapter—threaded hole
162b adapter—screw
163 adapter—plate end
164 adapter—mounting plate
165 adapter—plate screw
190 release position
191 home position
192 extended position
200 cover
201 cover—hole
202 enclosure
203 nut
204 thrust washer
205 button
206a driveshaft—split ring wire retainer
206b driveshaft—radial groove
207a driveshaft—split ring wire retainer (not shown)
207b driveshaft—radial groove
208 worm gear
209 worm gear—pawl driver drum
210 driveshaft—integral ratchet
210a driveshaft—ratchet tooth
210b driveshaft—tooth run
210c driveshaft—tooth rise
211 pawl
211b pawl—pawl tooth
211c pawl—pawl pocket
211d pawl driver drum—edge
211e pawl driver drum—ratchet face
212a worm gear—driveshaft hole
212b driveshaft—driven end
214 driveshaft
215 drive shaft—surface
216a tuning socket
216b tuning socket driver
216c tuning socket—bevel
217a socket drive
217b drum driver—axial socket
219 driveshaft—drum end
219a drum end—upper string hole
219b drum—upper string hole
221a drum end—lower string hole
221b drum—lower string hole
222 disc
222a drum end—disc surface
222b disc—axial opening
223 disc driver
223a drum end—threaded hole
223b string clamp—threaded pestle
224 string clamp
225a mortar
225b pestle
226 low friction drum
226a low friction drum—drum surface
227 high friction drum
227a high friction drum—drum surface
228 groove drum
228a groove drum—drum surface
229 disc drum
231 worm
233 worm—washer
234a worm—screw
234b worm—screw hole
234c enclosure—screw hole (not shown)
235 worm—plug end
236 driver
236a driver—body
236b button—driver body cavity (not shown)
237 button driver
237a driver—threaded hole
237b button—screw
237c button—recessed screw hole
300 mounting plate
301 mounting plate—mounting screw
302 mounting plate—pawl drive hole
303 worm
304a worm—plug end
304b worm—tuning socket driver
305a worm—threaded hole
305b collar—hole
305c collar—set screw
306 collar
307 thrust washer
216c collar—tuning socket bevel (not visible)
216b driver—tuning socket driver
320 driveshaft—cosmetic seal
321a driveshaft—split ring retainer
321b driveshaft—radial groove
216a driveshaft—tuning socket
216c driveshaft—tuning socket bevel
322 driveshaft—driven end
323 worm gear
323a worm gear—drive surface
323b pawl drive—surface
323c plate—axial hole
323d pawl drive—axial hole
323e worm gear—axial hole
323f driveshaft—surface
324a worm gear—key
324b pawl drive—keyway
325 worm gear—thrust washer
326 pawl drive
327 pawl drive—flange
328 pawl drive—drive ring
329 pawl drive—pawl
329a pawl drive—pawl tooth
330 pawl drive—pocket
331 driveshaft
331a string clamp
331b string clamp—threaded screw
331c driveshaft—axial threaded hole
331d driveshaft—head bore
331e string clamp—head
331f string clamp—drive slot
338c string clamp—pestle
338d string clamp—mortar
332 driveshaft—recess
333a ratchet—tooth
333b ratchet—surface run
333c ratchet—surface rise
334 ratchet—drum
335 driveshaft—drum end
335a driveshaft—hex drum drive
335b disc drum—hex socket
336a driveshaft—threaded hole
336b driveshaft—drum retainer screw
337a driveshaft—drum retainer washer
337b disc drive—washer recess
338a driveshaft—string hole
338b driveshaft—string hole
338c string clamp—pestle
338d string clamp—mortar
335b disc drive—hex socket
337b disc drive—washer recess
338b disc drive—string hole
341 disc drive—integral fixed disc
342 disc drive—disc
342a disc drive
342b disc drive—axial hole
343 disc drive—shaft support
344 disc string drum
344a disc string drum—surface
345 groove string drum
345a groove string drum—surface
346 low friction string drum
346a low friction string drum—surface
347 high friction string drum
347a high friction string drum—surface
350 button—driver
351 driver
216b tuning socket driver
351a driver—body
351c driver—hole
351d driver—clevis
351e driver—stop
352a button—hole
352b button—cavity
353 screwdriver
353a screwdriver—blade
353c screwdriver—yoke
353d screwdriver—hole
353f screwdriver—stop
354 threaded pin
354a threaded pin—threaded end
122 speed clamp—chamber
138b speed clamp—retainer
138c speed clamp—radial groove
400 speed clamp
401 speed clamp—housing
402 speed clamp—jaw
402a speed clamp—protrusion
404 headless end-stock—nut
405 headless end-stock
406 speed bridge
407a speed bridge—saddle
407a pin bridge—saddle
407b pin bridge—tie block
408 pin bridge
409 pin bride—string hole
410 pin bridge—lower transition
411 pin bridge—upper transition
412 pin bridge—reversal member
413 pin bridge—string stop
414a pin bridge—front surface
414b pin bridge—clamping surface
415 pin bridge—string clearance slot
416 saddle point
417 entry point
418 exit point
419 top point
420 end point
421 string point
422 clamping point
500 Torres headstock
502 Torres—vertical wall
503 Torres—drum hole
505 conventional headstock
508 conventional headstock—8 mm hole

### DETAILED DESCRIPTION

The descriptions set forth below in connection with the appended drawings are intended as a description of various embodiments and are not intended to represent the only embodiments in which the concepts and features described herein may be practiced. The following descriptions include specific details for the purpose of providing a thorough understanding of various concepts. However, it will be apparent to those skilled in the art that these concepts may be practiced without these specific details.

### Description of the First Embodiment

Cylinder nomenclature: 150 is used in the following description to apply to 150a and 150b variants. An additional c in nomenclature denotes collar 108f is present. Piston nomenclature: 140 is used in the following description to apply to 140a and 140b variants.

### External Features

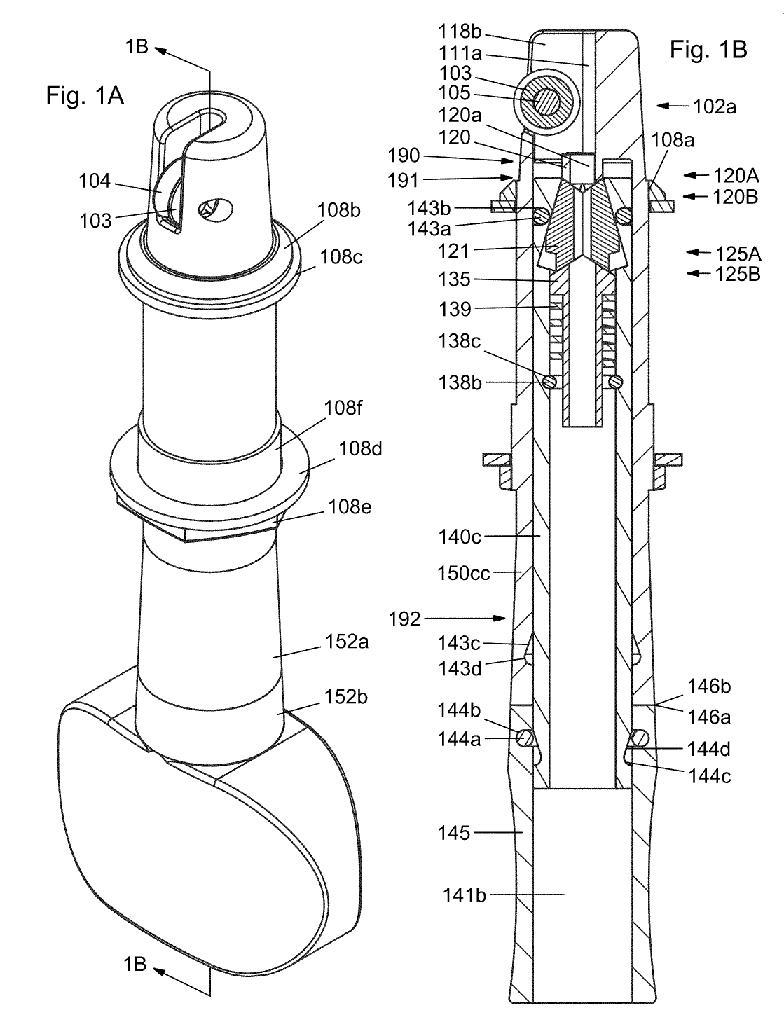

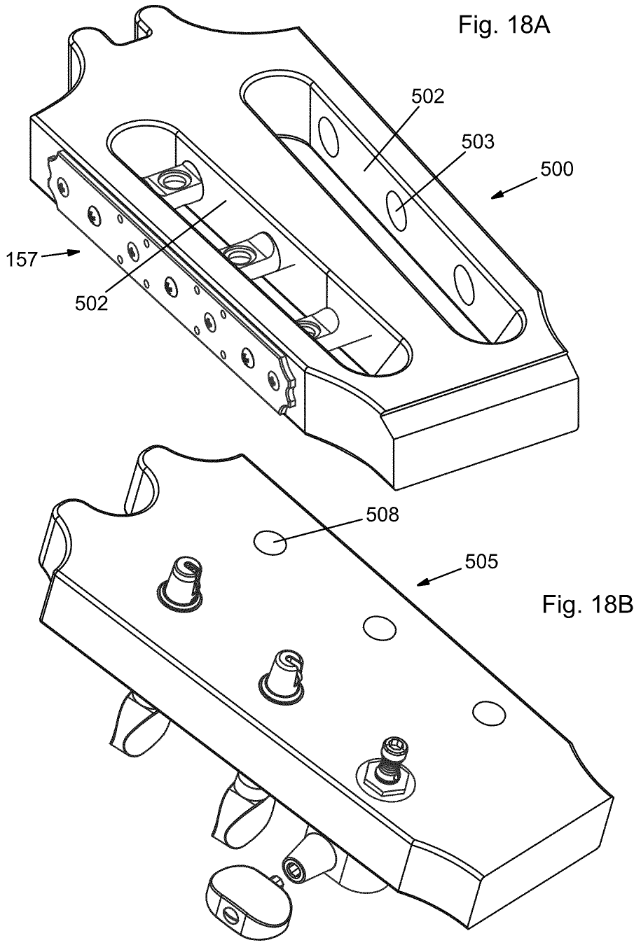

The embodiment of tuner shown in FIG. 1A is adapted to be fixedly disposed in an 8 mm hole 508 in peg head 505 (FIG. 18B) of a stringed musical instrument such as a guitar. FIG. 1A depicts capstan 102a, pulley 103, pulley axel 105, threaded shoulder 108a, nut 108b, thrust washer 108c, threaded collar 108f, thrust washer 108d, nut 108e, cylinder 150cc, and button 145. The moving parts (FIG. 1B) are pulley 103, piston 140cc, piston jaws 121 shown in closed position 121-C, piston plunger 135, piston plunger spring 139, button 145 and moving retainers 143a and 144a.

### Cylinder

A generally tube cylinder 150cc, has a forward end having an integral capstan 102a with a thread 108a which cooperates with nut 108b and thrust washer 108c. Rearward threaded shoulder 108f of cylinder 150cc cooperates with nut 108e and thrust washer 108d. An axially aligned longitudinal elongated keyway 142b, in the internal wall of cylinder 150cc, cooperates with key 142a of piston 140c. Cylinder 150cc has a rearward internal radial groove 143d and a radial groove bevel 143c from deepest point of groove 143d forward to inside surface of cylinders 150cc. Split ring wire retainer 144a cooperates with groove 143d and bevel 143c. At the rearward end of cylinder 150cc, a flare 152a cooperates with flare 152b of button 145. At present, I contemplate cylinder 150cc to be made from one piece of steel, but other materials are possible such as titanium, aluminum, and carbon fiber. I presently anticipate a mounting diameter of 8 mm, but other diameters are possible, and overall size and shape may vary.

Capstan 102a has an axial string hole 111a therethrough, and a string clearance slot 118b projecting outwardly from its axis. The rearward end of capstan 102a has a release stub 120 with an axially located string hole 120a. Forward inclined outwardly radiating surfaces 120A, at rearward end of release stub 120, cooperates with forward inclined outwardly radiating surfaces 120B of jaws 121 in chamber 122 of piston 140c.

### Pulley

Pulley 103, has string groove 104 on the radial surface, and is affixed with an axel 105 having a threaded end 106a that cooperates with threaded hole 106b in the integral capstan 102a. I presently contemplate for this embodiment pulley 103 to be made from plastic, but other materials such as steel, brass and aluminum may be used. I presently further contemplate axel 105 to be made of steel.

### Jaws

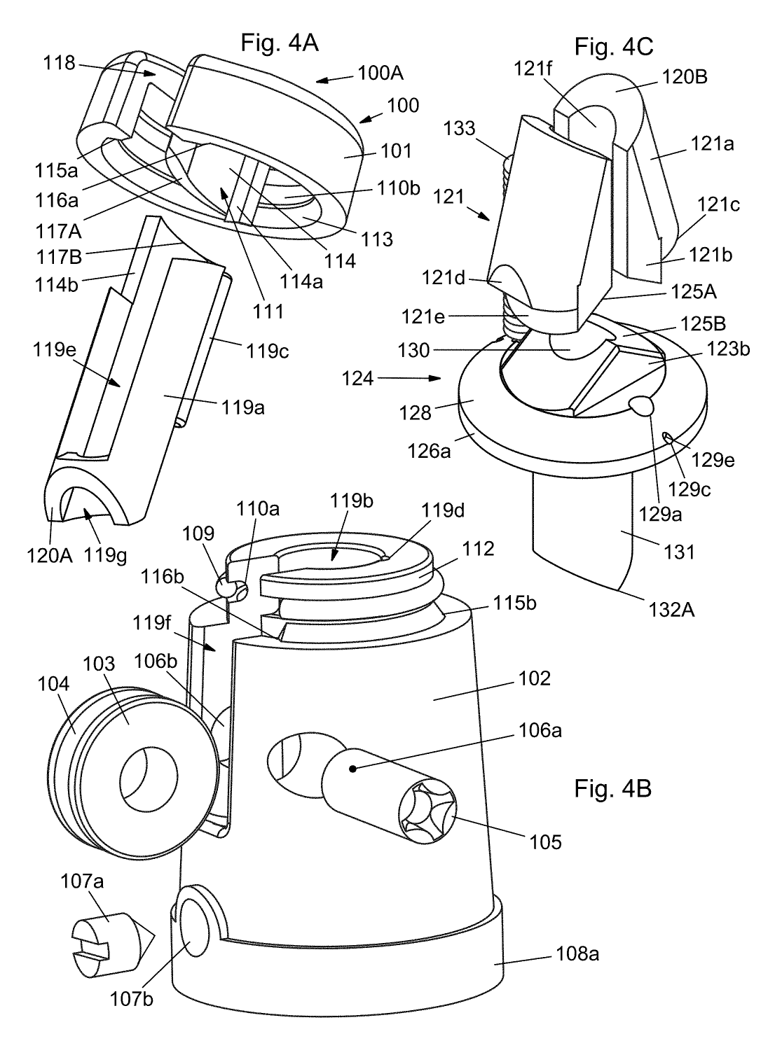

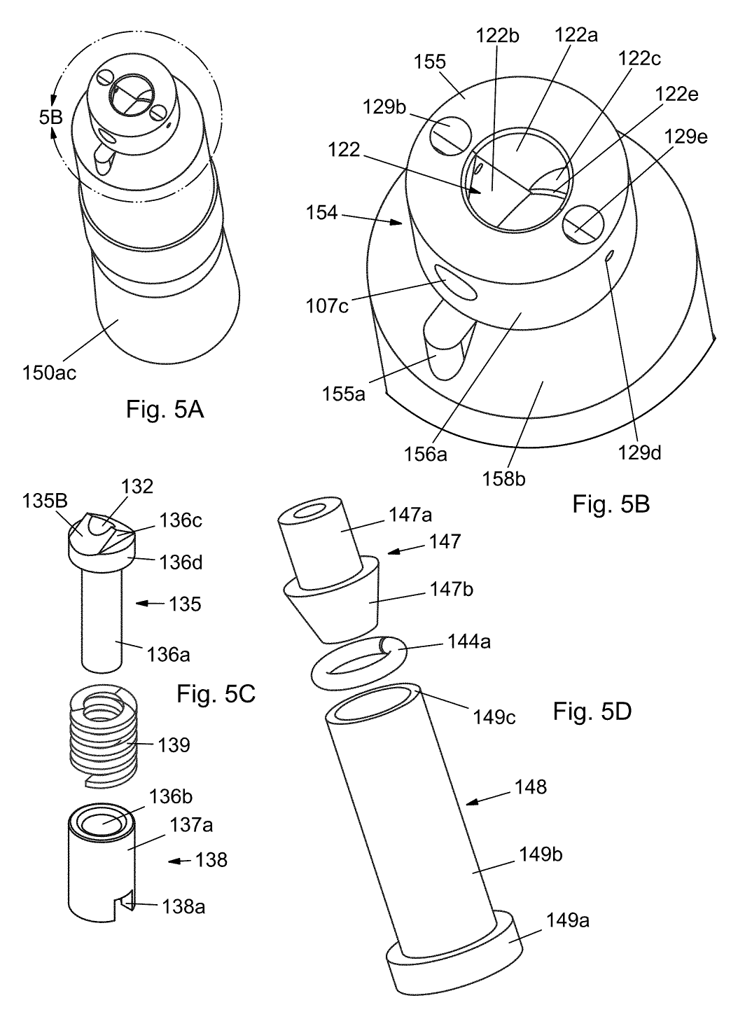

Two cylinder jaws 121 of FIG. 4C and 5B have axially aligned string gripping surfaces 121f and offset inclined surfaces 121a which are slidably disposed and cooperate with offset inclined surfaces 122a of cylinder chamber 122. Surfaces 121a of jaw 121 and surfaces 122a of chamber 122 can hold a variety of profiles, but I presently contemplate for this embodiment a semi-circle profile. Flat surfaces 121b are flush with surfaces 121a.

At present, I contemplate string gripping surface 121f having an axially centered, semi-circle or oval groove, having an aggressive string gripping texture. The radius of this groove is determined by the diameter of string 98. I presently contemplate a common radius for nylon strings E and G, A and B, and D and Eh. For steel string acoustic and electric guitars, I presently contemplate common radii for specified strings, but many possibilities exist with the plethora of string gauges that are in present use by musicians. At present I further contemplate jaws 121 to be made of steel, but other materials such as titanium, bronze, or plastic could be used.

The forward end of cylinder jaws 121 of FIG. 1B, 4C, have forward inclined outwardly radiating surfaces 120B which cooperate with forward inclined outwardly radiating surfaces 120A of release stub 120. The rearward end of cylinder jaws 121 have rearward inclined outwardly radiating surfaces 125A which cooperate with rearward inclined outwardly radiating surfaces 125B of piston plunger 135. At present, I anticipate for this embodiment outwardly radiating surfaces to be 35 degrees, but other angles are also possible.

Rearward surface 121e of jaw 121 clears stop wall edge 122e of chamber 122 when in open position 121-O. Stop 121c cooperates with stop wall 122c of chamber 122. I presently contemplate jaws 121 and chamber 122 as described, but many variations are possible. The rearward end of jaws 121 could have a flat surface that cooperates with a flat washer plunger urged by a spring, wave washer, or a magnetic washer having a non-magnetic spacer.

### Piston

A generally cylindrical piston 140c is slidably disposed in cylinder 150cc and has key 142a projecting into keyway 142b of cylinder 150cc. Piston 140c has chamber 122 with openings forward and rearward therethrough. Piston jaws 121 cooperate with chamber 122. Piston 140c has an external thread 141a which cooperates with unthreaded inside wall of cylinder 150cc and threaded hole 141b of button 145. At present, I contemplate a square or Acme thread for external thread 141a, but other thread forms could be used.

The rearward end of piston 140 has an external radial groove 144c having a bevel 144d from deepest point of groove 144c forward to surface of piston 140c. Split ring wire retainer 144a cooperates with radial groove 144b of button 145. The forward end of piston 140c, has a radial groove 143b which permits a cooperating split ring wire retainer 143a to compress flush to the surface of piston 140c. Retainer 143a cooperates with groove 143d and bevel 143c. I presently envisage for this embodiment, piston 140c to be made of steel but other materials could also be used. I also currently contemplate, an outside diameter of 6mm, but other dimensions could be used.

### Piston Plunger

Piston plunger 135 has a slidably disposed surface 136d that cooperates inside piston 140c and has an axial string hole 132 therethrough. Flat surface 136c cooperates with flat surface 122b of chamber 122. The forward end of piston plunger 135 has a rearward inclined outwardly radiating surfaces 135B that cooperates with rearward inclined outwardly radiating surfaces 125A of jaws 121. Flat surfaces 123b cooperate with flat surfaces 122b of piston chamber 122.

A compression spring 139 cooperates with piston 140c and barrel 136a. Spring 139 is retained by split ring wire retainer 138b cooperating with radial groove 138c of inside wall of piston 140c. I presently anticipate for this embodiment, piston plunger 135 to be made of plastic, but other materials such as steel could be utilized. I imagine at present spring 139, to be made of steel, but other materials such as brass or stainless steel could be used.

### Button

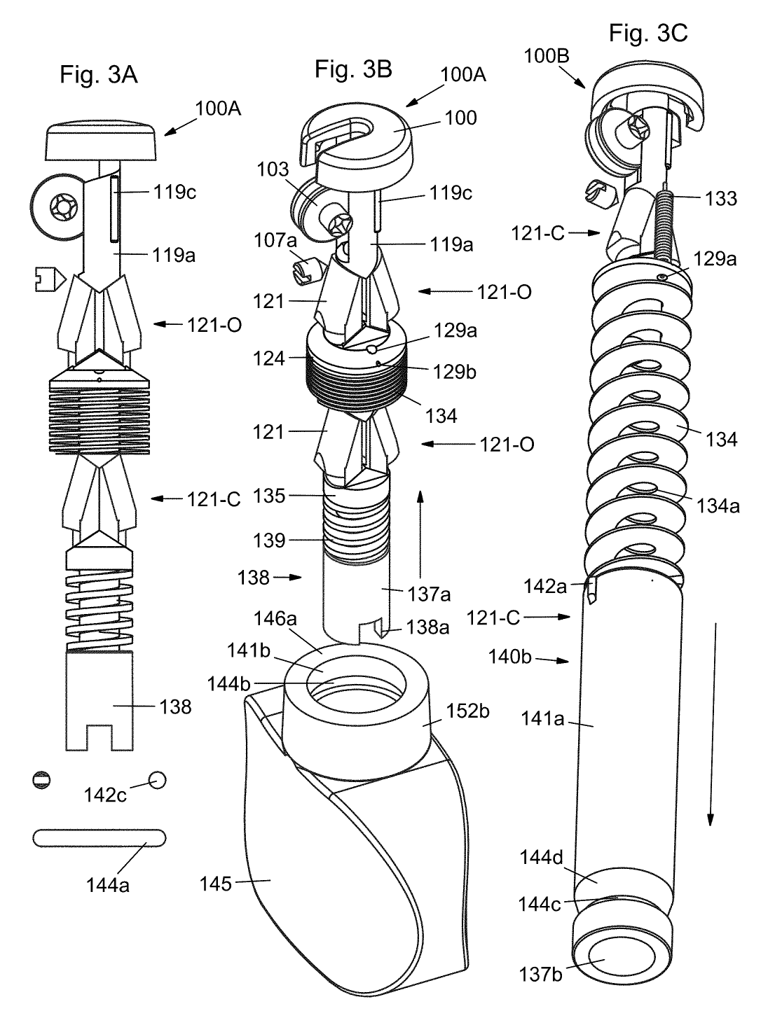

Button 145 of FIG. 3B, has a threaded hole 141b axially therethrough, which threadedly engages with external threads 141a of piston 140 and 140c. At the forward end of button 145 is a radial groove 144b in threaded hole 141b, which cooperates with split ring wire retainer 144a and groove 144c and bevel 144d of piston 140c. Flare 152b cooperates with flare 152a of cylinder 150. Button 145 has an ergonomic shape with smooth curves. I anticipate at present, the use of steel for a construction material, but other materials such as brass, bronze, aluminum or plastic could be utilized.

### Operation of the First Embodiment

### Jaws

Jaws 121 of FIG. 4C, 5B, have offset inclined surfaces 121a which cooperate with offset inclined surfaces 122a of chamber 122. As jaws 121 move forward in chamber 122, string gripping surfaces 121f remain parallel to the axis and move together. Piston plunger 135 is urged forward by spring 139, which is compressed by split ring wire retainer 138b, which in turn urges jaws 121 forward, and offset inclined surfaces 122a urge jaws 121 together in chamber 122. Tension of spring 139 maintain an initial clamping pressure between string gripping surfaces 121f of jaws 121.

String 98 is positioned axially with string gripping surfaces 121f of jaws 121 in closed position 121-C. When chamber 122 moves rearward, or string 98 moves forward, relative to each other, initial clamping pressure provides friction to prevent slippage between string gripping surfaces 121f and string 98, thereby gripping string 98. As pressure is increased between string gripping surfaces 121f and string 98, grip of string gripping surfaces 121f increase. In summation, when string 98 is pulled or pushed forward, or when chamber 122 is moved rearward, jaws 121 grip.

When chamber 122 moves forward or string 98 moves rearward, relative to each other, initial clamping pressure between string 98 and string gripping surfaces 121f, urge jaws 121 rearward and apart. String gripping surfaces 121f lose their grip on string 98, which then slide on surface of string 98. In summation, when string 98 is pushed or pulled rearward, or chamber 122 is moved forward, jaws 121 do not grip.

Flat surfaces 123b cooperate with flat surfaces 122b of cylinder chamber 122, thereby maintaining surfaces 125B aligned with surfaces 125A, as well as maintaining alignment of spring housing holes 129a and 129b. Rearward surface 121e of jaws 121 clear stop wall edge 122e of chamber 122 when in open position 121-O. Stops 121c of jaws 121 and stop wall 122c of chamber 122 produces a positive stop to jaws 121 translation.

Trimmed surface 121d permits installation of jaws 121 into chamber 122. A jaw 121 is positioned into chamber 122 in open position. String gripping surfaces121f of second jaw 121 is placed on string gripping surface of first jaw 121 and trimmed surface 121d of second jaw 121 is slid past stop wall edge 122e.

Trimmed surface 121d, parallel to cylinder's axis, reduces the surface area of surface 121a, however, a semi-circle profile, unlike a flat surface, retains longitudinal working length of surface 121a, whereby jaw 121 load is evenly distributed. A semi-circle profile in chamber 122 can be achieved by boring two plug bottom holes of appropriate diameter, position, angle, and depth in the forward end of the piston 140 and 140c. Material between bores is then removed. A semi-circle profile facilitates ease of manufacture and negates the need to have chamber 122 to be removable to install jaws 121.

### Release Position

Release position places jaws 121 of piston chamber 122 in open position 121-O, thereby permitting string 98 to be inserted or removed without resistance. Piston plunger spring 139 maintain a forward force on piston plunger 135. When piston 140c is translated to release position 190, inclined surfaces 120A and 125B urge jaws 121 apart, and offset inclined surfaces 121a cooperate with offset inclined surfaces 122a of piston chamber 122, thereby placing piston jaws 121 in open position 121-O. When piston 140c is returned to retract position 191, spring 139 maintain an initial clamping pressure on piston plunger 135, and offset inclined surfaces 121a which cooperate with offset inclined surfaces 122a of piston chamber 122, urge jaws 121 together, thereby placing cylinder jaws 121 in closed position 121-C.

### Retaining Systems

### Button to Piston

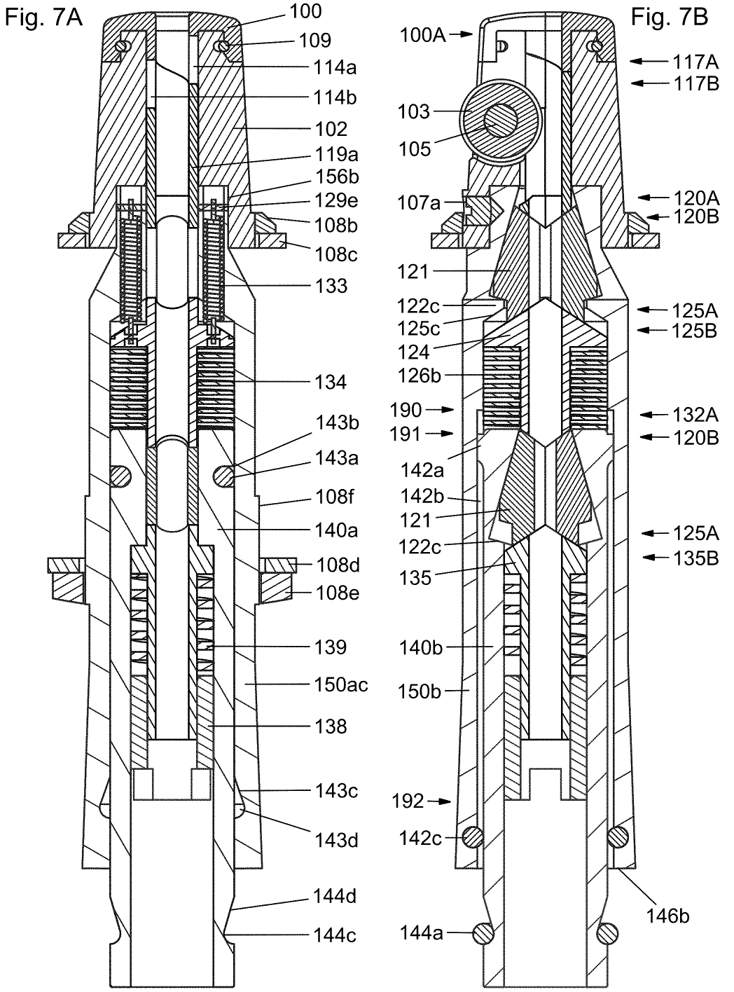

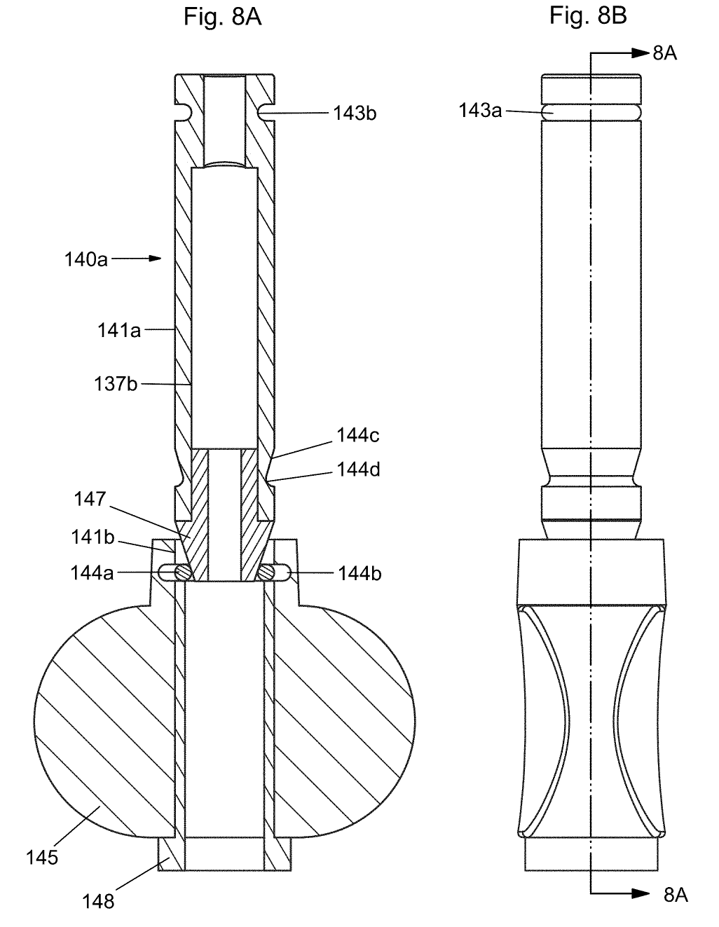

Button 145 of FIG. 3B, C, is supported for rotation relative to cylinder 150 and 150cc, but is held against forward longitudinal movement by surface 146b of cylinder 150 and 150cc (FIG. 7B) and surface 146a of button 145. A radial groove 144b in threaded hole 141b at the forward end of button 145 permits a cooperating split ring wire retainer 144a to expand flush to surface of threaded hole 141b. A radial groove 144c, in external thread 141a at the rearward end of piston 140a, is positioned to cooperate with groove 144b at release position 190. Groove 144c has a bevel 144d from deepest point forward to the surface of piston 140 and 140c. When button 145 is rotated and/or spun to rearward end of piston 140 and 140c, retainer 144a slides and contracts on bevel 144c and seats in groove 144c at release position 190. This creates a positive stop and thereby retains button 145 to piston 140 and 140c. Upon forward rotation of button 145, retainer 144a slides and expands on bevel 144d to surface of threaded hole 141b and then rides on the surface of exterior thread 141a. The retention system of button 145 to piston 140 and 140c is concealed, secure from consumer tampering, and facilitates ease of assembly and manufacturing.

### Installation Tool

Installation of retainer 144a into button 145 requires an expander tool 147 of FIG. 5D, 8A, B, and a stanchion tool 148. Stanchion tool 148 is a cylinder which cooperates with internal thread 141b of button 145 and has a base 149a with means to be mounted with its axis vertical to a work surface. Cylinder 149b has a seat 149c at the opposite end of base 149a. Expander tool 147 is a cylinder which cooperates with internal thread 137b of piston 140 and 140c. Cone 147b at one end of expander tool 147 cooperates with threaded hole 141b of button 145 and the retainer 144a.

Button 145 is axially aligned and positioned on cylinder 149b, and retainer 144a is positioned in threaded hole 141b of button 145 and sits on seat 149c. Threaded hole 137b of piston 140 and 140c is slid over cylinder 147a of expander tool 147. Expander tool 147 is positioned having cone 147b axially aligned with stanchion tool 148 and making contact with retainer 144a. A downward force is applied to piston 140 and 140c, thereby urging cone 147b to expand retainer 144a into groove 144b of button 145. Translating button 145 away from base 149a on stanchion tool 148 permits the downward force to continue to urge retainer 144a into groove 144d of piston 140 and 140c. Button 145 and piston 140 are removed from stanchion tool 148 and expander tool 147. The installation procedure is rapid and permits automation of the process.

### Piston to Cylinder

Referring to FIG. 7A, 3C, radial groove 143b is in the forward end of pistons 140a and 140c to permit a cooperating split ring wire retainer 143a to compress flush to the surface of pistons 140a and 140c. Radial groove 143d, on the inside wall at the rearward end of cylinders 150a and 150cc, is positioned to cooperate with radial groove 143b at extended position 192 of pistons 150a and 150cc. Radial groove 143d has a bevel 143c from deepest point, forward to surface of cylinders 150a and 150cc. Retainer 143a is compressed to surface of pistons 140a and 140c during translation in cylinders 150a and 150cc. Retainer 143a expands on bevel 143c until fully expanded when seated in radial groove 143d, being extended position 192. This creates a positive stop and retains pistons 140a and 140c to cylinders 150a and 150cc. Retainer 143a compresses again as it slides up bevel 143c on reversal of translation. Retention of pistons 140a and 140c to the cylinders 150a and 150cc is concealed, secure from consumer tampering, and facilitates ease of assembly and manufacturing.

### Peg Head Installation

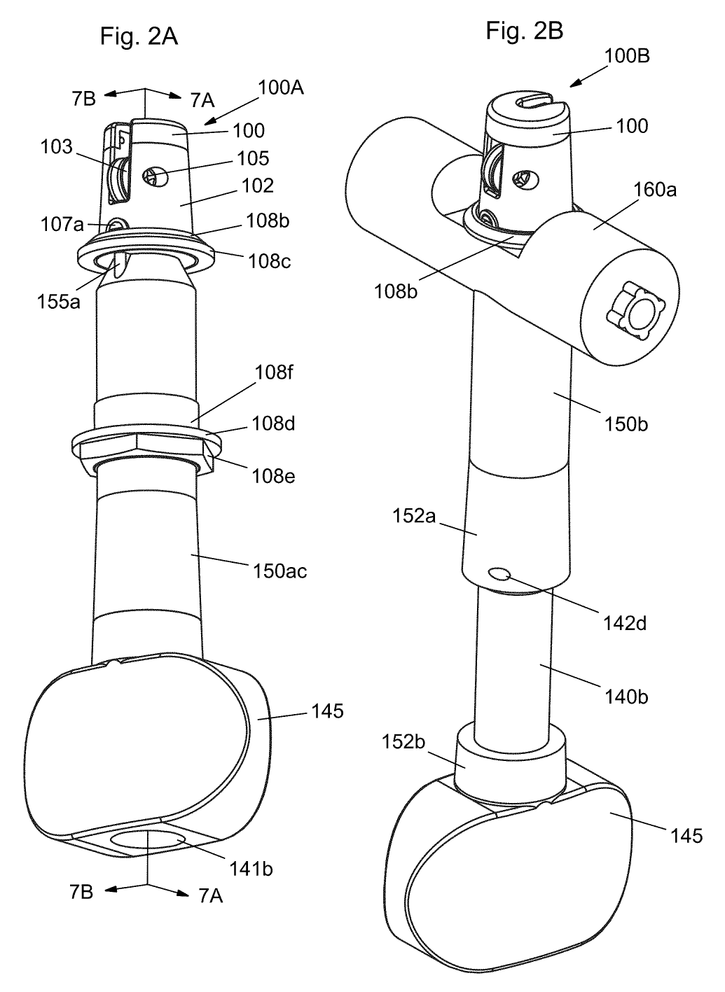

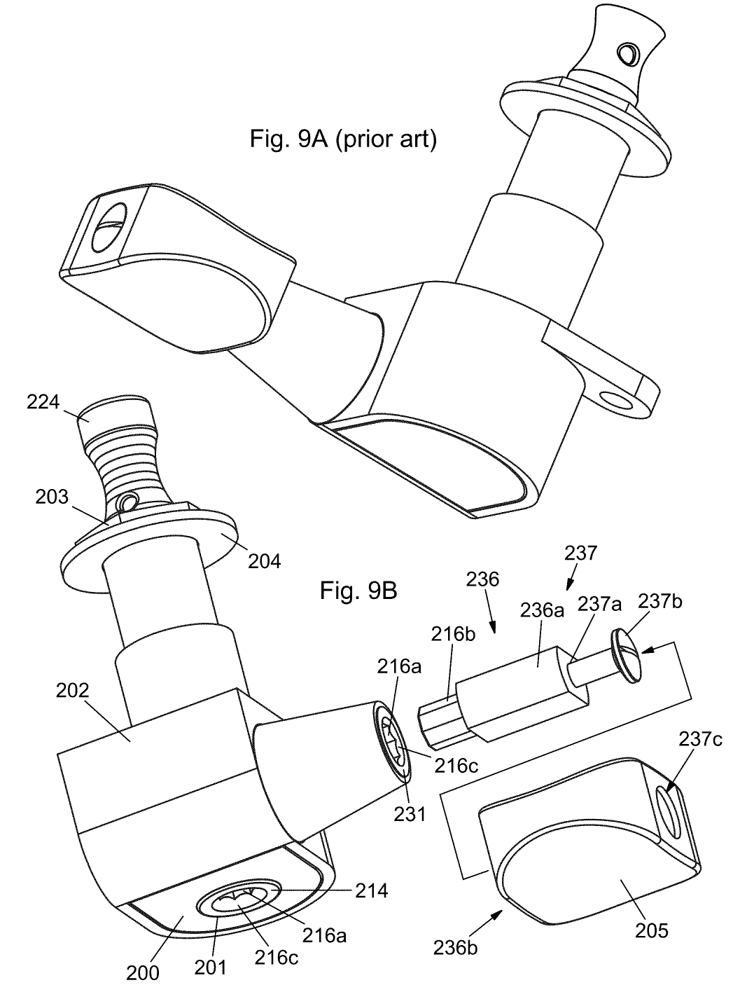

To install tuner of embodiment of FIGS. 2A and 18B, into 8 mm holes 508 of peg head 505, nut 108b, and thrust washer 108c are removed from the capstan 102, and the thrust washer 108d and nut 108e are loosened rearward. Tuner of embodiment of FIG. 2A, is slid in hole 508 from beneath the peg head 505, and then the thrust washer 108c is replaced, and nut 108b is positioned and tightened by hand. Threaded collar 108f permits various thicknesses of peg heads 505 to be accommodated. Depending on the thickness of peg head 505, and the dimensional accuracy of the 8 mm hole 508, the underside of 8 mm hole 508 may need to be reamed to accommodate the threaded collar 108f. Position thrust washer 108c and snug nut 108b up by hand, and then tightened with an appropriate wrench, while holding tuner in correct alignment with the string path. The tuner of embodiment of FIG. 1A requires only one hole to be bored in peg head 505, in contrast to two holes as required by ubiquitous prior art tuners of FIG. 9A, thereby removing an operation from production.

### End-User Operation

### Release Position—String Replacement

To insert string 98 rotate and/or spin button 145 to the end of piston 140c, then push button 145 forward to release position 190. String 98 is inserted into string hole 111a of capstan 102a and therethrough exiting button 145. Relax forward pressure on button 145 and rotate button about one revolution to bring tuner to retracted position 191. Pull string 98 taut if string 98 is secured at other end. To remove string 98 rotate and/or spin button 145 to the end of piston 140c, then push button 145 forward to release position 190. Pull string 98 out of capstan 102a or if string 98 is cut, pull out of button 145.

### Retracted Position

Placing piston 140c in retracted position is simple. Rotate and/or spin button 145 to rearward end of piston 140 and 140c, and rotate button 145 forward about one revolution to clear release position 190. Push button forward until drive surface 146a of button 145 contacts driven surface 146b of cylinder 150. Piston 140 is now in retracted position.

### Extended Position

Pull button 145 rearward until retainer 143a contacts groove 143d of cylinder 150cc. Piston 140 is now in extended position.

### Tuning Method

### Course Tuning

Course tuning permits rapid string 98 replacement and tuning. It guarantees adequate piston travel to tune and maintain tune of string 98 until retirement. With button 145 in retracted position, and using button 145 as a bearing surface, pull string 98 by hand or by using a tensioning device to course tune. To commence fine tuning, rotate button. The resultant fine-tuning ratio is determined by the pitch of thread 140b and 141b of piston 140 and button 145. The ability to rapidly course tune permits utilizing lower thread pitches and thereby finer tuning ratios without impacting string replacement time. Bear in mind musicians may be content with the present conventional ratios and may resist any changes. In summary, pull on string 98 manually or use a tensioning device to course tune, then fine tune conventionally. Factories will appreciate the speed an instrument can be strung, tuned and test played.

### Description of the Second Embodiment

Cylinder nomenclature: 150 is used in the following description to apply to 150a and 150b variants. An additional c in nomenclature denotes collar 108f is present. Piston nomenclature: 140 is used in the following description to apply to 140a and 140b variants. Adapter nomenclature: 160 is used in the following description to apply to 160a, 160b, and 160c variants.

### External Features

The embodiment of tuner shown in FIG. 2A is designed for mounting in peg head 505 of a stringed musical instrument such as a guitar. This tuner has a selector knob 100, shown in home position 100A, a capstan 102, pulley 103, pulley axel 105, set screw 107a, threaded shoulder 108a, (FIG. 4B), nut 108b, thrust washer 108c, alignment tab 155a threaded collar 108f, thrust washer 108d, nut 108e, cylinder 150ac, button 145, and internal thread 141b of button 145.

The embodiment of tuner shown in FIG. 2B is designed for mounting into adapter 160 and has selector knob 100, shown in pull position 1008, adapter 160a, nut 108b, cylinder 150b, flare 152a, threaded hole 142d, piston 140b, flare 152b and button 145.

The embodiment of tuner in FIG. 3A is an exposed side view of tuner in retracted position 191 with selector knob 100 in home position 100A, and with cylinder 150, button 145, and piston 140 removed. Cylinder jaws 121 are in open position 121-O and piston jaws 121 are in closed position 121-C for fine-tuning.

The embodiment of tuner shown in FIG. 3B is an exposed isometric of tuner in release position 190, with selector knob 100 in home position 100A, and with cylinder 150a and piston 140a removed. Cylinder jaws and piston jaws 121 are both in open position 121-O for string 98 to be installed or removed.

The embodiment of tuner shown in FIG. 3C is an exposed isometric view of tuner in extended position 192 with selector knob 100 in pull position 1008, and with cylinder 150b and button 145 removed. Cylinder jaws and piston jaws 121 are both in closed position 121-C for course tuning. Alignment spring 134 is in extended position 191.

Referring to FIG. 3B, the moving parts are selector knob 100, pulley 103, release actuator 119a, two cylinder jaws 121, shown in open position 121-O, cylinder plunger 124, two cylinder plunger springs 133 and alignment spring 134 (FIG. 3C), piston jaws 121 shown in closed position 121-C, piston plunger 135, piston plunger spring 139, adjustable nut 138 with adjustment slot 138a, piston 140, and button 145.

### Selector Knob

The selector knob 100 of FIGS. 4A and 4B, comprises a skirt 101 that cooperates with a capstan neck 112 at the forward end of capstan 102. The skirt 101 has a bevel 113 of 45 degrees on the inside rearward edge, and a retainer groove 110b above it that cooperates with a retainer groove 110a on capstan neck 112. A split ring wire retainer 109, is positioned in groove 110a in neck 112. The selector knob 100 has a rearward axially aligned cam shaft 114 with an axially located string hole 111 therethrough. A string clearance slot 118 projects outwardly from the axis of string hole 111, and cam shaft 114 has a cam surface 117A at its rearward end.

Cam shaft 114 has a surface stop 114a that cooperates with a surface stop 114b of release actuator 119a. Selector knob 100 has knob stop 115a that cooperates with capstan knob stop 115b, and another knob stop 116a that cooperates with capstan knob stop 116b. This permits stationing of selector knob 100 and release actuator 119a at home position 100A and pull position 1008. I presently contemplate that selector knob 100 to be made of steel, but many other materials are possible, including brass and plastic materials. I presently anticipate bevel 113 to be 45 degrees but many other angles will perform its function adequately.

### Release Actuator

The release actuator 119a of FIG. 4A has a string clearance slot 119e situated forward of the forward inclined outwardly radiating surface 120A, which projects outwardly from the axis and cooperates with string clearance slot 118 of selector knob 100. Release actuator 119a has a key 119c that cooperates with keyway 119d of capstan 102. Release actuator 119a has a cam surface 117B on its forward end which cooperates with cam surface 117A of cam shaft 114. I presently contemplate that release actuator 119a to be fabricated from steel but other materials could be suitable.

### Capstan

A generally stub capstan 102 of FIG. 4B adapted to be fixedly disposed in a hole 508 in a peg head 505 (FIG. 18B) of a stringed musical instrument, by a nut 108b cooperating with an external threaded shoulder 108a on capstan 102. Capstan 102 has an axial opening 119b extending therethrough with an axially aligned keyway 119d which cooperates with key 119c of release actuator 119a. Capstan 102 has a string clearance slot 119f projecting outwardly from axial opening 119b which cooperates with string clearance slot 118 of selector knob 100. Capstan 102 has a threaded hole 106b in string clearance slot 119f which engages with threaded end 106a of pulley axel 105. Capstan 102 has a rearward socket 156b (FIG. 7A) that threadedly engages with thread 156a of cylinder neck 154 (FIG. 5B). Alignment of capstan 102 to cylinder 150a and 150b is via set screw 107a which threadedly engages set screw hole 107b of capstan 102, and self-centers with centering hole 107c (FIG. 5B). I presently contemplate for this embodiment capstan 102 to be made of steel, but other materials are possible, including, plastics and reinforced plastics, and variations in size and shape are also possible.

### Pulley—Refer to First Embodiment

### Cylinder

A generally tube cylinder 150 of FIG. 5B has a cylinder neck 154 at the forward end. Capstan 102 has a rearward socket 156b (FIG. 7A) that threadedly engages with thread 156a of cylinder neck 154. Capstan 102 and cylinder 150 are adapted to be fixedly disposed in an 8 mm hole 508 in peg head 505 (FIG. 18B) of a stringed musical instrument. Threaded collar 108f cooperates with nut 108b and thrust washer 108c, wherein various thicknesses of peg heads 505 are accommodated.

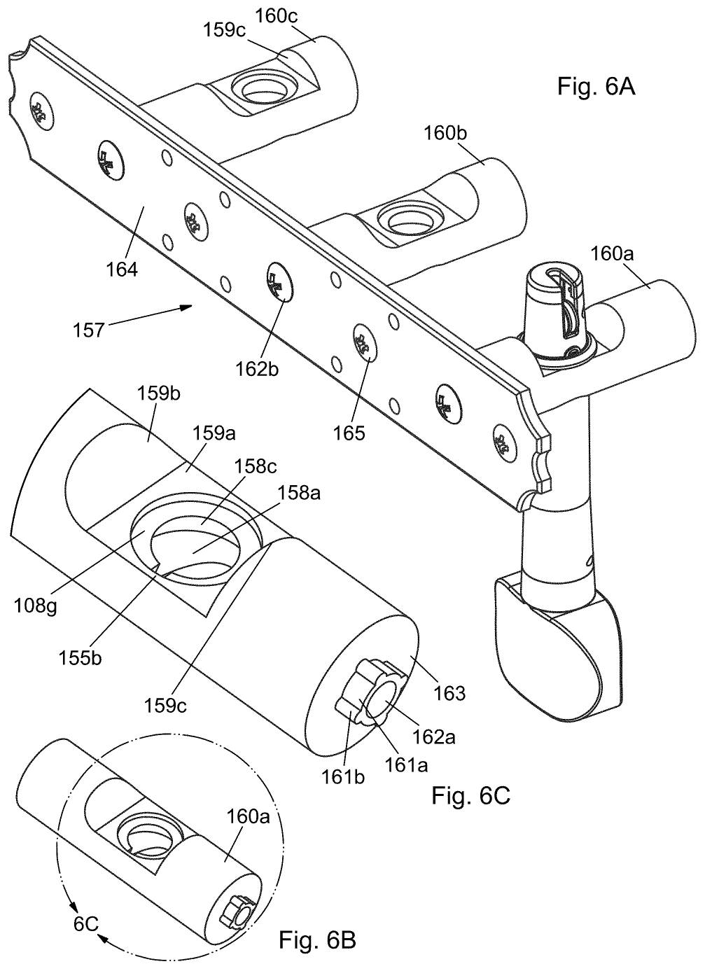

At the forward end of cylinder 150 of FIG. 5B, is an adapter bevel 158b which slopes to the exterior wall of cylinder 150a and 150b. Seated on this bevel 158b is an alignment tab 155a that cooperates with alignment slot 155b of optional adapter 160 (FIG. 6C). At the rearward end of cylinder 150, a flare 152a cooperates with flare 152b (FIG. 2B) of button 145.

Cylinders 150ac of FIG. 7A and 150cc of FIG. 1B, have a rearward internal radial groove 143d and a radial groove bevel 143c from deepest point of groove 143d forward to inside surface of cylinders 150ac and 150cc. Cylinder 150b of FIG. 7B has two set screws 142c and two cooperating holes 142d (FIG. 2B), flushed at the surface of keyway 142b and are positioned on the inside surface of the rearward end of cylinder 150b, being at the furthest point of translation of piston 140b.

The forward end of cylinders 150 of FIG. 5B have chambers 122 with connected openings forward and rearward. Cylinder chamber 122 has two offset inclined surfaces 122a relative to the axis, whereof they commence at the forward opening, and end at two cylinder stop walls 122c, at their farthest extent from the axis. Between surfaces 122a are flat surfaces 122b. Behind stop wall 122c is bevel 125c (FIG. 7B). Stop wall edge 122e clears rearward surface 121e of jaw 121.

At present I contemplate for this embodiment, cylinder 150 to be made of steel, but other materials are possible such as titanium, aluminum, and carbon fiber. I presently anticipate for this embodiment a mounting diameter of 8 mm, but other diameters are possible, and overall size and shape may vary.

### Jaws—Refer to First Embodiment

### Cylinder Plunger

A slidably disposed cylinder plunger 124 of FIG. 4C, cooperates inside cylinder 150, and has an axial string hole 130 therethrough, to permit passage of string 98. The forward end of cylinder plunger 124 has a rearward inclined outwardly radiating surface 125B, that cooperates with the rearward inclined outwardly radiating surfaces 125A of cylinder jaws 121. Flat surface 123b cooperates with flat surface 122b of chamber 122 (FIG. 5B) as does bevel 128 (FIG. 4C) with bevel 125c (FIG. 7B) of cylinder 150. Two extension springs 133 have each end terminated with a hook which cooperates with drift pins 129e. Drift pins 129e are situated at each end of axially aligned spring housing holes 129b in cylinder 150, and in spring housing holes 129a in cylinder plunger 124. Drift pins 129e cooperate with drift pin holes 129c and 129d. I envisage presently for this embodiment, that cylinder plunger 124 be made of plastic but other materials such as steel could be utilized. I presently contemplate springs 133 to be made of steel but other materials could be used., I contemplate at present drift pins 129e, to be made of steel or plastic, but other materials could be used.

### Alignment Spring

An alignment spring 134 of FIG. 3A, B, C, 7A which is positioned inside cylinders 150 between piston 140 and cylinder plunger 124, has an axial string hole 134a. I presently contemplate spring 134 being constructed of flat wire or flat plastic, but other shapes and materials could be used. I contemplate at present string hole 134a to be sized to accommodate the largest diameter of string 98, on an instrument, but two or more different sizes may be used.

### Piston—Refer to First Embodiment

### Piston Plunger

Piston plunger 135 of FIG. 5C, 3A, B, 7A, B, has a slidably disposed surface 136d that cooperates inside piston 140 and has an axial string hole 132 therethrough. Flat surface 136c cooperates with flat surface 122b of chamber 122. The forward end of piston plunger 135 has a rearward inclined outwardly radiating surfaces 135B that cooperates with rearward inclined outwardly radiating surfaces 125A of jaws 121. Flat surfaces 123b cooperate with flat surfaces 122b of piston chamber 122. Barrel 136a of piston plunger 135 cooperates with hole 136b of adjustable nut 138. A compression spring 139 cooperates with piston 140 and barrel 136a. Adjustable nut 138 has an adjustment slot 138a, and a threaded exterior 137a which threadedly engages with internal thread 137b of piston 140. I presently anticipate for this embodiment, piston plunger 135 and adjustment nut 138 to be made of plastic, but other materials such as steel could be utilized. Spring 139, I imagine at present to be made of steel, but other materials such as brass or stainless steel could be used.

### Button—Refer to First Embodiment

### Adapter

As illustrated, the tuner of embodiment of FIG. 2B is mounted to adapter 160a with selector knob 100 in pull position, and button 145 in extended position 192. Cylinder 150b has no threaded collar for aesthetic consideration for use with adapter 160a.

Adapter 160 of FIG. 6C is a 10 mm diameter rod having a seat 159a recessed into its surface and having one seat wall 159c at one end of the recess and a seat slope 159b at the other end. The vertical wall 159c aligns with the vertical walls 502 (FIG. 18A) of the Torres headstock 500. The seat wall 159c and seat slope 159b are cosmetic, so any shape is acceptable, and seat 159a may be the full length and in a different position on the adapter 160. I presently envisage adapter 160 to be made from aluminum, but other materials are suitable.

### Operation of the Second Embodiment

### Jaws—Also Refer to the First Embodiment

Flat surfaces 123b cooperate with flat surfaces 122b of cylinder chamber 122, thereby maintaining surfaces 125B aligned with surfaces 125A, as well as maintaining alignment of spring housing holes 129a and 129b. Rearward surface 121e of jaws 121 clear stop wall edge 122e of chamber 122 when in open position 121-O. Stops 121c of jaws 121 and stop wall 122c of chamber 122 produces a positive stop to jaw 121 translation. This positive stop protects plunger springs 133 from being overextended by insertion of an oversized or misguided string 98, which could drive jaws 121 and plunger 124 rearward.

### Home Position

Home position 100A permits string 98 to be inserted and removed, and places cylinder jaws 121 in open position 121-O, which permits manual fine and course tuning, and course tuning using a tensioning device. Rotating selector knob 100 of FIG. 3A, B, to station at home position 100A, moves knob stop 116a into contact with knob stop 116b of capstan 102. String clearance slot 118 of selector knob 100 aligns with string clearance slot 119f of capstan 102 and string clearance slot 119e of release actuator 119a.

Cam surface 117A of cam shaft 114 cooperates with cam surface 1178 of release actuator 119a, and urges release actuator rearward. Release actuator 119a translates in axial hole 119b of capstan 102. The release actuator 119a is held from rotation by key 119c cooperating with keyway 119d of capstan 102. String clearance slot 119e permits the release actuator 119a to clear pulley 103 and string 98 wrapped over pulley 103 during translation.

Referring to FIG. 3A, B, when surfaces 120A of release actuator 119a urge surfaces 120B of jaws 121 rearward, surface 125A of jaws 121 urge surfaces 125B of cylinder plunger 124 rearward. The inclined surfaces 120A and 125B urge jaws 121 apart, thereby placing cylinder jaws 121 in open position 121-O. The rearward movement of cylinder plunger 124 extends cylinder plunger springs 133 and compresses alignment spring 134.

### Pull Position

Pull position places cylinder jaws 121 in closed position 121-C which permits manual and tensioning device course tuning. Rotating selector knob 100 of FIG. 3C, 4A, B, 7A, B, to station at pull position 1008, moves knob stop 115a into contact with knob stop 115b, and surface stop 114a into contact with surface stop 114b of release actuator 119a. The cam surface 117A of cam shaft 114 permits surface 117B and release actuator 119a to move forward. Cylinder plunger springs 133 sequentially urge cylinder plunger 124 and surfaces 125B forward, thereby urging surfaces 125A and 120B of jaws 121 and surface 120A of release actuator 119a forward. The offset inclined surfaces 121a which cooperate with offset inclined surfaces 122a of cylinder chamber 122, urge piston jaws 121 together, thereby placing cylinder jaws 121 in closed position 121-C.

### Extended Position

Pull button 145 of FIG. 2B, 3C, 6A, B, rearward until keys 142a contacts set screws 142c of cylinder 150b, or retainer 143a contacts groove 143d of cylinders 150a and 150c. Piston 140 is now in extended position.

### Release Position

Referring to FIG. 3B, release position places jaws 121 of cylinder chamber 122 and piston chamber 122 in open position 121-O, thereby permitting string 98 to be inserted or removed without resistance.

Selector knob 100 of FIG. 3B, 7B, is stationed in home position 100A, thereby positioning cylinder jaws 121 in open position 121-O, and piston plunger spring 139 maintains a forward force on piston plunger 135. When pistons 140 are translated to release position 190, inclined surfaces 132A and 135B urge jaws 121 apart, and offset inclined surfaces 121a cooperate with offset inclined surfaces 122a of piston chamber 122, thereby placing cylinder jaws 121 in open position 121-O.

When pistons 140 are returned to retract position 191, springs 139 maintain a forward force on piston plunger 135, and offset inclined surfaces 121a, which cooperate with offset inclined surfaces 122a of piston chamber 122, urge jaws 121 together, thereby placing cylinder jaws 121 in closed position 121-C.

### String Alignment

During one course tuning method, pistons 140 (FIG. 7A, B), are returned to retracted position 191, and during retraction, friction from string gripping surface 121f could urge string 98 to bend or collapse upon itself. Alignment spring 134 prevents string 98 from collapsing during translation to retracted position 191, thereby freeing a hand from keeping string 98 taut to prevent this occurrence. Alignment spring 134 allows rapid pumping of button 145 during one method of course tuning.

Alignment spring 134 (FIG. 3C) is positioned between piston 140 and cylinder plunger 124. String hole 134a aligns string 98 with the axial center of cylinders 150. Alignment spring 134 expands and contracts with piston 140 translations, thereby maintaining string 98 alignment and preventing string collapse. Removal of optional spring 134 would increase piston translation range with modification to length of keyway 142b and cylinder plunger barrel 131.

Adjustment nut 138 (FIG. 3B, 5C), has an external thread 137a which threadedly engages with internal thread 137b of piston 140. Adjustment nut 138 has an adjustment slot 138a which permits initial clamping pressure of spring 139 to be set by a slot screwdriver. If tension is too high, string collapse can occur during retraction of piston 140. If tension is too low, jaws 121 fail to grip string 98. Correct tension setting permits jaws 121 to slide along string 98 during retraction without collapse, and having adequate friction to grip string 98 during extension.

### Retaining Systems

### Selector Knob to Capstan

The selector knob 100 of FIG. 4A, B, 7A, B, is affixed to the neck 112 of capstan 102 by a concealed split ring wire retainer 109 in the following manner. Release actuator 119a is inserted into axial hole 119b of capstan 102. Retainer 109 is expanded and released in groove 110a of neck 112 and then aligned with string clearance slot 119f. Selector knob 100 is positioned over neck 112 in home position 100A and pressed down. Retainer 109 is compressed as it slides up bevel 113 to wall of skirt 101, thereby compressing retainer 109 flush to the surface of neck 112. Retainer 109 expands into groove 110b of skirt 101 when fully deployed, thereby securing selector knob 100 to capstan 102. This installation method is accomplished in a few seconds, therefore being inexpensive, concealed and secure from consumer tampering.

### Button to Piston—Refer to First Embodiment

### Piston to Cylinder—Refer to First Embodiment

### Piston 140b to Cylinder 150b

Cylinder 150b of FIG. 2B, 7B, has two threaded holes 142d cooperating with two set screws 142c, which function as a stop to key 142a of piston 140b in extended position 192. Holes 142d of cylinder 150b pass through keyways 142b transversely, and are flush to the inside surface of cylinder 150b. Removal of set screws 142a permits assembly and disassembly of piston 140b to and from cylinder 150b.

### Peg Head Installation—Refer to First Embodiment

### Adapter Assembly and Installation

A left and a right adapter assembly 157 of FIG. 6A, consists of 3 adapters 160 per side, adapter EE 160a, adapter AB 160b, and adapter DG 160c, affixed to mounting plates 164. The adapter 160, has a vertical transverse tuner hole 158a positioned to align with string 98 path to instrument nut 404 which clears other tuners. The tuner hole 158a cooperates with the cylinder 150. Bevel 158c cooperates with adapter bevel 158b (FIG. 5B) of cylinder 150. Recess 108g cooperates with threaded shoulder 108a of capstan 102 (FIG. 4B).

One end of adapter 160 (FIG. 6C), has stub 161a that cooperate with left and a right hand mounting plates 164, which have the standard spacing of 35 mm between tuners. The stub has four keys 161b which cooperate with four keyways of plate 164 and axial threaded hole 162a which cooperates with mounting screw 162b. The stub 161a has a length that is shy of the thickness of plate 164, enabling screw 162b to clamp plate 164 to adapter 160.

To install the adapter assembly 157, slide the left and right adapter assemblies 157 into the Torres headstock 500 (FIG. 18A) and affix with screws 165. Remove nut 108b and thrust washer 108c from each tuner, and slide the tuners from beneath the headstock 500, up into hole 158a of the adapter 160, with alignment tab 155a (FIG. 2A) cooperating with alignment slot 155b (FIG. 6C). Replace nuts 108b, without thrust washers 108c, snug by hand, and then tighten with appropriate tool.

### End-User Operation

### String Installation and Removal

The installation of string 98 into tuner of embodiment of FIG. 3B, is easy to accomplish. Rotate selector knob 100 to home position and rotate and/or spin button 145 to the end of piston 140, then push button 145 forward to release position 190. Insert string 98 into string hole 111 of selector knob 100 from above, until string 98 exits button 145. There is no resistance to this operation as all jaws 121 are in open position 121-O. Relax forward pressure on button 145 and rotate button about one revolution to bring tuner to retracted position 191. Pull string 98 taut.

String 98 removal is also easy. With selector knob 100 in home position 100A, release tension on the string 98 by rotating and/or spinning the button 145 to the end of piston 140.

Push button 145 forward to release position 190 and pull string 98 up and out of selector knob 100, or down and out through button 145, if string 98 has been cut.

### Course Tuning

Course tuning permits rapid string 98 replacement and tuning. It guarantees adequate piston travel to tune and maintain tune of string 98 until its retirement. The ability to rapidly course tune permits utilizing lower thread pitches and thereby finer tuning ratios without impacting string replacement time. Bear in mind musicians may be content with the present conventional ratios and may resist any changes.

### Course Tuning Method 1

With string 98 installed in tuner of embodiment of FIG. 2B, rotate selector knob 100 to pull position 1008. Position button 145 in retracted position 191 (FIG. 7B). Pull rearward on button 145 to increase tension on string 98. Return button 145 to retracted position 191. If desired pump one or more times on button 145 to course tune appropriately. Return button 145 to retracted position 191, and rotate button 145 about one revolution to transfer string 98 tension from cylinder jaws 121 to piston jaws 121. To commence conventional fine tuning, return selector knob 100 to home position 100A.

With selector knob 100 stationed in pull position 1008 (FIG. 3C), when button 145 is pulled to increase tension on string 98, piston jaws 121 grip string 98. Cylinder jaws 121 in closed position 121-C do not grip as string 98 slides past them. When applied tension is released, cylinder jaws 121 commence to grip string 98 and maintain tension. When button 145 is returned to retracted position 191, piston jaws 121 do not grip string 98, as string 98 slides past piston jaws 121. In summary, select pull position 1008, pull or pump button 145 to course tune, return to home position 100A and fine tune conventionally.

### Course Tuning Method 2

With string 98 installed in tuner of embodiment of FIG. 2B, rotate selector knob 100 to pull position 1008. Position button 145 in retracted position 191 (FIG. 7B), and then rotate button 145 to increase tension on string 98. Return button 145 to retracted position 191. If desired, rotate button 145 to further increase tension on string 98. Rotate button 145 about one revolution to transfer tension from cylinder jaws 121 to piston jaws 121. Return selector knob 100 to home position 100A to commence conventional fine tuning.

With selector knob 100 in pull position 1008, as button 145 is rotated to increase tension on string 98, piston jaws 121 grip string 98. Cylinder jaws 121 in closed position 121-C do not grip as string 98 slides past them. When applied tension is released, cylinder jaws 121 commence to grip string 98 and maintain tension. When button 145 is returned to retracted position 191, piston jaws 121 do not grip string 98, as string 98 slides past piston jaws 121. In summary, select pull position 1008, rotate button to course tune, return to home position 100A and fine tune conventionally.

### Fine and Course Tuning Method 3

With string 98 installed in tuner of embodiment of FIG. 2A, rotate selector knob 100 to pull position 1008. Position button 145 in retracted position 191 (FIG. 7B), and using button 145 as a bearing surface, pull rearward on string 98 manually or using a tensioning device to course tune string 98. To commence conventional fine tuning, rotate button 145 about one revolution to transfer tension from cylinder jaws 121 to piston jaws 121, then return selector knob 100 to home position 100A.

With selector knob 100 parked in pull position 1008, as string 98 is pulled to increase tension, piston jaws 121 grip string 98, and cylinder jaws 121 in closed position 121-C, do not grip as string 98 slides past them. Upon releasing tension on string 98, cylinder jaws 121 grip string 98. In summary, select pull position 1008, pull on string 98 manually or using a tensioning device to course tune, return to home position 100A and fine tune conventionally.

### Fine Tuning Method 4

With string 98 installed in tuner of embodiment of FIG. 3A, rotate selector knob 100 to home position 100A. Position button 145 in retracted position 191 (FIG. 7B), and rotate button 145 to tune in conventional manner. With selector knob 100 in home position 1008, cylinder jaws 121 are in open position 121-O, and do not grip string 98. Piston jaws 121 in closed position 121-C grip string 98. In summary, select home position 100A and fine tune conventionally.

### Description of the Third Embodiment

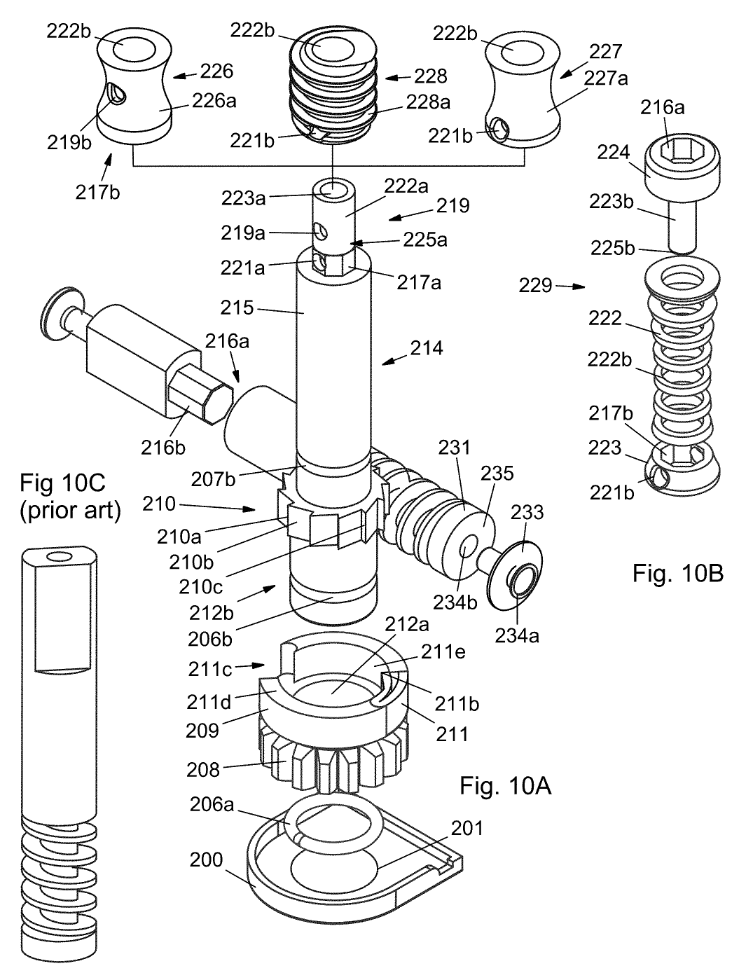

Driveshaft 214 of FIG. 10A, has an integral ratchet 210 with a plurality of teeth 210a. Each tooth having a run 210b and a rise 210c. Driveshaft 214 has a driven end 212b comprising a tuning socket 216a (FIG. 9B) with bevel 216c, and radial groove 206b. Drum end 219 has a reduced diameter having disc surface 222a. At the base of disc surface 222a is an axial socket drive 217a having a transverse string hole 221a therethrough. Mid-point on drum end 219 is another transverse string hole 219a. At the end of disc surface 222a is an axial threaded hole 223a which terminates with mortar 225a at the commencement of socket drive 217a. I currently contemplate for this embodiment, driveshaft 214 to be made of steel, but other materials for example could be titanium, aluminum, or bronze.

Worm gear 208 of FIG. 10A has a plurality of teeth, and has an axial integral pawl driver drum 209 having two cooperating pawl pockets 211c which house pawls 211, having teeth 211b. Worm gear 208 has an axial driveshaft hole 212a therethrough which is slidably and rotatably disposed on driven end 212b. Worm gear 208 is sandwiched between ratchet 210b and split ring wire retainer 206a, cooperating with radial groove 206b in driven end 212b. I presently anticipate for this embodiment, pawls 211, to be constructed from an elastic plastic material and have the shape of a letter V, that permits them to be squeezed together and then released to return to their former shape and position, but other materials such as spring steel, could be used.

Enclosure 202 of FIG. 9B, to be fixedly disposed on a stringed musical instrument, has thrust washer 204 and nut 203. Enclosure 202 is slidably and rotatably disposed on drum end 219 of driveshaft 214, and is sandwiched between ratchet 210 and split ring wire retainer 207a (not shown) which cooperates with radial groove 207b in driveshaft 214. Enclosure 202 has cooperative cover 200 having a hole 201 which cooperates with the diameter of driven end 212b of drive shaft 214. I currently contemplate for this embodiment, enclosure 202 to be made of zinc, but other metals or materials such as plastic could be used.

Worm 231 of FIG. 10A is rotatably mounted in enclosure 202 and cooperates with worm gear 208. Plug end 235 has a threaded hole 234b which cooperates with enclosure 202, and is affixed by a cooperative screw 234a. The other end has tuning socket 216a. Currently, I contemplate for this embodiment, worm 231 to be crafted from steel, but other materials for example, could be titanium or bronze. Prior art worm of FIG. 10C is utilized on the remaining tuners which do not require a button-driver 237.

Button 205 has an ergonomic shape with smooth curves and is of traditional appearance, and has a cavity 336b which cooperates with body 236a of driver 236. Button 205 has an affixing screw recess 237c which cooperates with screw 237b. I anticipate at present for this embodiment the use of plastic, wood, or mother of pearl for a construction material, but other materials such as, aluminum or brass could be utilized.

Driver 236 of FIG. 9B has a body 236a which cooperates with an axial cavity 236b in button 205. One end of driver 236 terminates in a tuning socket driver 216b and the other end has an axial threaded hole 237a. Screw 237b threadedly engages in threaded hole 237a and seats in recessed screw hole 237c, thereby affixing button 205 to driver 236. The assembly of button 205 and driver 236 is called a button-driver 237. Tuning socket driver 216b is magnetized. Currently, I contemplate for this embodiment, driver 236 to be crafted from steel, but other materials for example, could be titanium, aluminum, or brass. Button-driver 237 could be cast or machined from a single billet.

Disc drum 229 of FIG. 10B has disc driver 223 which has an axial socket 217b therethrough, which cooperates with socket drive 217a. Disc driver 223 has string hole 221b therethrough, cooperating with string hole 221a. A plurality of discs 222 have an axial opening 222b therethrough, which cooperate rotatably and slidably on disc surface 222a of drum end 219. Discs 222 are retained by string clamp 224 which threadedly engages with threaded hole 223a of drum end 219. String clamp 224 terminates at one end with tuning socket 216a, and at the other end pestle 225b, which cooperates with mortar 225a. I presently anticipate for this embodiment, disc drum 229 and discs 222 to be fabricated in steel, as well as string clamp 224, but other non-ferrous metals are suitable, and plastic is a possibility for discs 222. I presently envisage pestle 225b having a polished finish with a round over edge and mortar 225a having a frictional texture, but various shapes and sizes such as ball and sockets may be utilized.

Low friction drum 226 of FIG. 10A has an axial opening 222b extending therethrough, and an axial socket 217b, cooperating with socket drive 217a of drum end 219. String hole 219b extends transversely therethrough, cooperating with string hole 219a of drum end 219. Low friction drum 226 has a string surface 226a with reduced resistance to string 98. At present I contemplate for this embodiment, low friction drum 226 to be constructed from a solid piece of ceramic with a polished finish, or a steel drum, or other material, with a surface coating of polished ceramic. I presently further contemplate for this embodiment, another material that could be utilized is fiber and carbon impregnated PTFE.

High friction drum 227 of FIG. 10A has an axial opening 222b extending therethrough, and an axial socket 217b, cooperating with socket drive 217a of drum end 219. String hole 221b extends transversely therethrough, cooperating with string hole 221a of drum end 219. High friction drum 227 has a string surface 227a with increased resistance to string 98. At present, I contemplate for this embodiment, high friction drum 227 to be constructed from steel with a vulcanized rubber surface, but other materials will be suitable.

Groove drum 228 has an axial opening 222b extending therethrough, and an axial socket 217b, cooperating with socket drive 217a of drum end 219. String hole 221b extends transversely therethrough, cooperating with string hole 221a of drum end 219. Groove drum 228 has an external helical groove 228a comprising non-parallel groove walls that narrow together at a predetermined angle towards the axis of groove drum 228. At present, I contemplate for this embodiment, groove drum 227 to be constructed from aluminum, or a steel drum that is vulcanized with a rubber surface, but other materials will be suitable.

### Operation of the Third Embodiment

Referring to FIGS. 10A and B, rotating worm 231 urges worm gear 208 to rotate, but worm gear 208 cannot urge worm 231 to rotate. When worm gear 208 is rotated, the integral pawl driver drum 209 rotates, thereby rotating pawls 211 positioned in pawl pockets 211c. Teeth 211b of pawls 211 urge teeth 210a of ratchet 210b to rotate driveshaft 214, and resists rotation of driveshaft 210 in opposite direction of rotation, thereby maintaining tension on string 98.

When torque is applied in one direction, directly to driveshaft 214, pawls 211 ride up run 210b of tooth 210a of ratchet 210, and then fall at rise 210c to another run 210b, thereby permitting rotation and course tuning of string 98.

Conversely, when torque is applied directly to driveshaft 214 in the other direction of rotation, teeth 210a of driveshaft 214 are held from rotation by teeth 211b of pawls 211. Pawl driver drum 209, having pawls 211 in pawl pockets 211c, are retained from rotation by teeth of worm gear 208 cooperating with worm 231, thereby not permitting rotation and maintaining tension on string 98.

Tuning socket driver 216b is magnetized to keep button-driver 237 secure to tuning socket 216a, but permits easy removal and replacement.

Low friction drum 226 increases tension equalization in string 98 which wraps around drum surface 226a. By encouraging slippage of string 98, rather than resisting it, the low friction coefficient rapidly equalizes the tension of the section of string 98 around drum 226, thereby achieving stable tune quickly.

High friction drum 227 reduces tension equalization in string 98 which wraps around drum surface 227a, by resisting tension equalization with a high friction coefficient, rather than encouraging it, and thereby achieving stable tune.

Groove drum 228 reduces tension equalization in string 98 which wraps around drum surface 228a. Increase in string tension urges string 98 to deform and wedge deeper into the groove of drum surface 228a, thereby increasing friction and grip. Increase in tension of string 98 also results in a decrease in the diameter of string 98 and thereby wedges string 98 deeper into the groove of drum surface 228a. Groove drum 228 resists tension equalization with a high friction coefficient, rather than encouraging it, thereby achieving stable tune.

Disc drum 229 increases tension equalization in string 98 which wraps around surface of drum 229. String 98, is secured by string clamp 224. Driveshaft 214 is rotated urging string 98 to wrap around discs 222. Tension equalization urges discs 222 to rotate independently of disc surface 222a of drum end 219 and each other, thereby equalizing the section of string 98 which is wrapped around disc drum 229. By encouraging tension equalization of string 98, rather than resisting it, the low friction coefficient rapidly equalizes the tension of the section of string 98 around drum 226, thereby achieving stable tune quickly.

### String Clamping

String clamp 224 has a pestle 225b with a polished surface and a round-over on its edge to prevent string 98 fracture during rotation. Mortar 225a has a frictional surface to increase grip on string 98 as pressure is increase on the string 98 as pestle 225b rotates during clamping. String holes 219a and 221a diameters may be selected according to the gauge of string 98 being clamped to aid centering of string 98 in mortar 225a. String 98 is inserted into string holes 221b and 221a and pulled taut if string 98 is secured at the other end. Button-driver 237 is disengaged from tuning socket 216a of worm 231 and is engaged in tuning socket 216a of string clamp 224. Button-driver 237 is rotated, thereby clamping string 98. Button-driver 237 is disengaged from string clamp 224 and engaged in appropriate tuning socket 216b. String clamp 224 eliminates tension equalization derived from string affixing knots through elimination of the knot to secure string 98.

### Course Tuning Method 1

Button-driver 237 is engaged in tuning socket 216b of driven end 212b of driveshaft 214. Button-driver 237 is rotated to course tune string 98 appropriately. Button-driver 237 is disengaged from tuning socket 216a of driveshaft 214 and engaged in tuning socket 216a of worm 231, whereby conventional fine tuning can commence. In summary, engage button driver 237 to driveshaft 214 and course tune.

### Course Tuning and Fine Tuning Method 2

A digital torque screwdriver has a tuning socket driver 216b installed in its chuck, and has been set to an appropriate torque for course tuning. Torque screwdriver is engaged in tuning socket 216b of driven end 212b of driveshaft 214. Torque is applied and then torque screw driver is disengaged from tuning socket 216a. Commence conventional tuning. In summary, engage digital torque screwdriver in driveshaft 214 and course tune, then disengage, commence conventional tuning.

As described, string 98 can be rapidly secured, rapidly course tuned using button-driver 237 or by using a digital screwdriver, and fine-tuned conventionally. The embodiment of FIG. 9B eliminates tension equalization derived from knots, reduces tension equalization of strings tensioned around drums, reduces the protracted time in string replacement, and is housed in an enclosure of traditional dimension, mounting and appearance.

### Description of the Fourth Embodiment

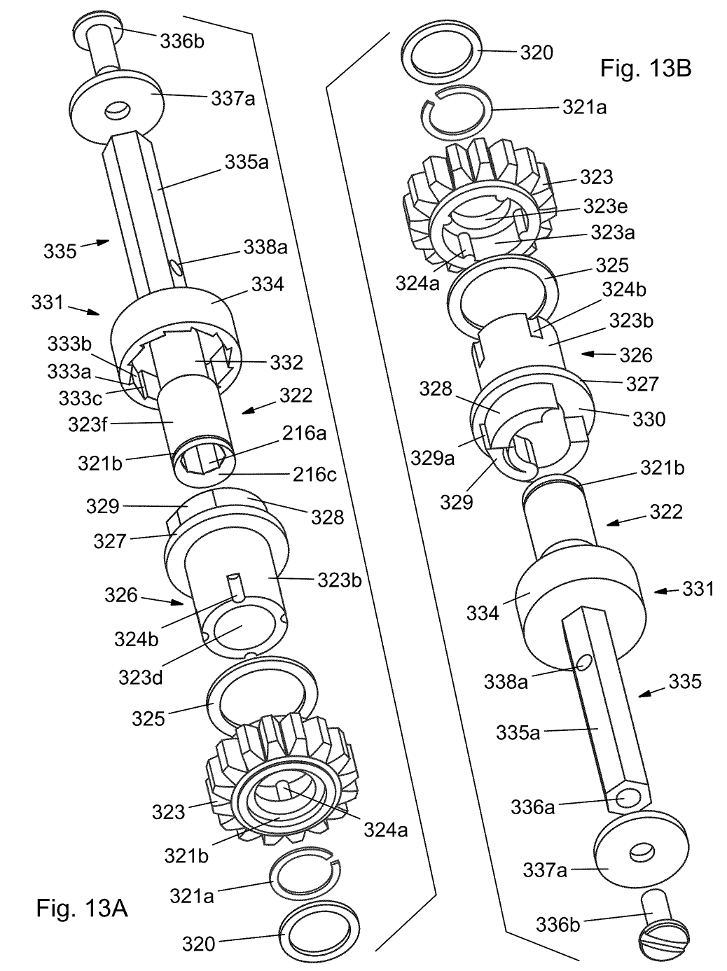

Driveshaft 331 of FIG. 13A, B, 15A, B, has an integral ratchet drum 334 with a plurality of internal teeth 333a. Teeth 333a have surface run 333b and a surface rise 333c. Driveshaft 331 has a drum end 335 with a hexagonal profile drum drive 335a, and having an end threaded hole 336a which cooperates with screw 336b and washer 337a. Driven end 322 comprises a head bore 331d with a forward tuning socket 216a incorporating a bevel 216c, and an axial threaded hole 331c. At the base of hole 331c is mortar 338d, which intersects transverse string hole 338a. Driven end 322 has a recess 332 at ratchet drum 334 and a radial groove 321b. I currently contemplate for this embodiment, driveshaft 331 to be made of steel, but other materials for example could be titanium, aluminum, or bronze. I presently anticipate mortar 338d to have a flat, frictional surface, but other shapes such as a socket could be used with various surfaces.

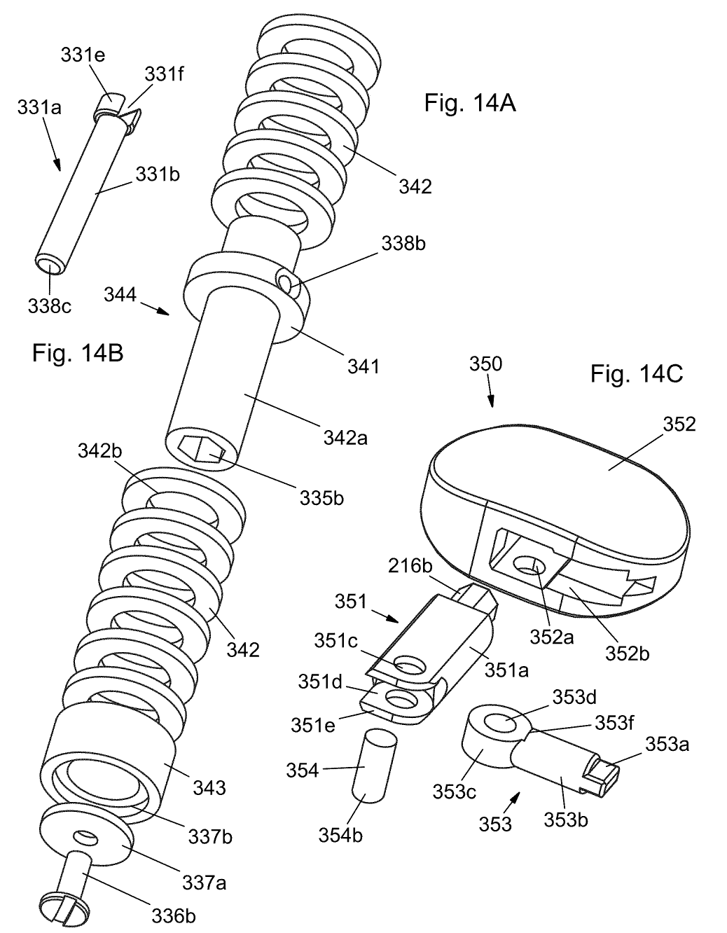

String clamp 331a of FIG. 14B, 15A, B, comprises a threaded screw 331b which threadedly engages with axial hole 331c in driven end 322 of driveshaft 331. One end of string clamp 331a has a head 331e with a drive slot 331f, which cooperates with head bore 331d. The other end has a pestle 338c which cooperates with mortar 338d at base of axial hole 331c. Currently I anticipate pestle 338c to have a flat polished surface with a round-over on its edge, but other shapes such as a ball could be used. I currently anticipate for this embodiment, string clamp 331a to be fabricated in steel but other metals could be used.

Worm gear 323 of FIG. 13A, B, has a plurality of teeth, and an axial hole 323e which slidably engages with driveshaft surface 323f. Worm gear 323 has a drive surface 323a which cooperates with pawl drive surface 323b and has four keys 324a which cooperate with keyways 324b of pawl drive 326. Worm gear 323 has a radial groove 321b which cooperates with split ring retainer 321a, and cosmetic seal 320 cooperates with surface 323f of driveshaft 331.

Pawl drive 326 has a drive ring 328 with two pawl pockets 330 which house two pawls 328. I presently anticipate for this embodiment, pawls 328, to be constructed from an elastic plastic material and have the shape of a letter V, that permits them to be squeezed together and then released to return to their former shape and position, but other materials such as spring steel could be used. Pawls 328 have a teeth 329a that cooperate with teeth 333a of ratchet drum 334. Pawl drive flange 327 cooperates with ratchet drum 334. Pawl drive axial hole 323d cooperates with surface 323f of driveshaft 331.

Pawl drive 326 and worm gear 323 rotatably and slidably sandwiches mounting plate 300 with two thrust washer 325 on either side (one depicted), and surface 323b cooperates with hole in mounting plate 300 to be fixedly disposed on a stringed musical instrument. Axial hole 323e of worm gear 323, and axial hole 323d of pawl drive 326 is slidably and rotatably disposed on driven end 322 of driveshaft 331, thereby being sandwiched between ratchet drum 334 and retainer 321a which cooperates with radial groove 321b of driveshaft 331. I presently contemplate for this embodiment, that worm gear 323 and pawl drive 326 to be fabricated in brass or other non-ferrous metals.

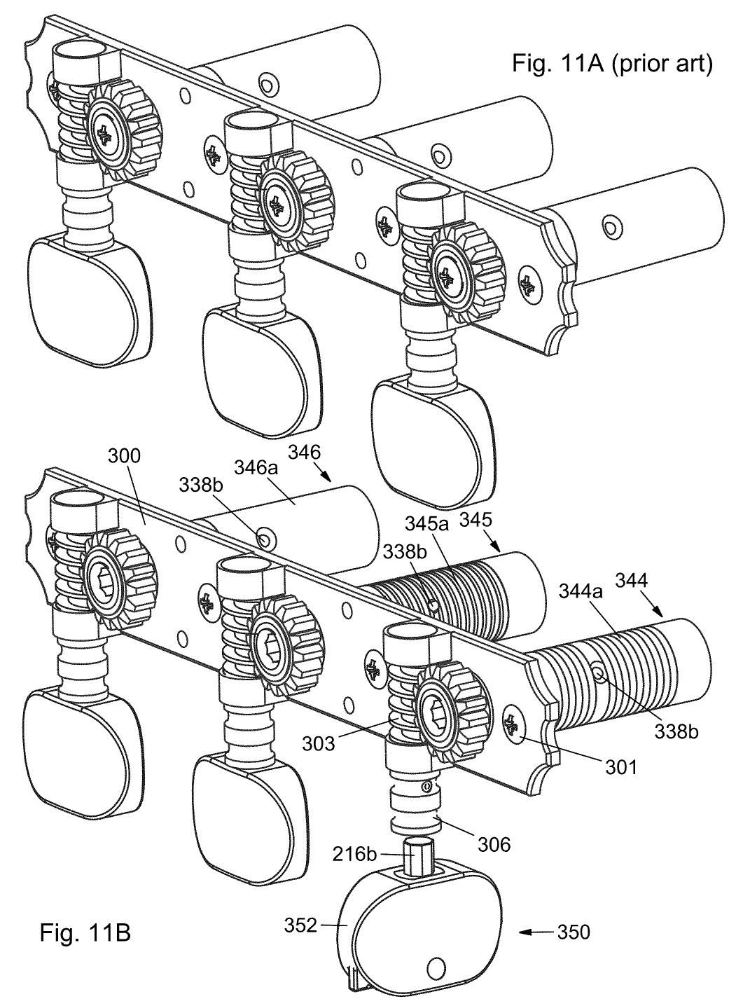

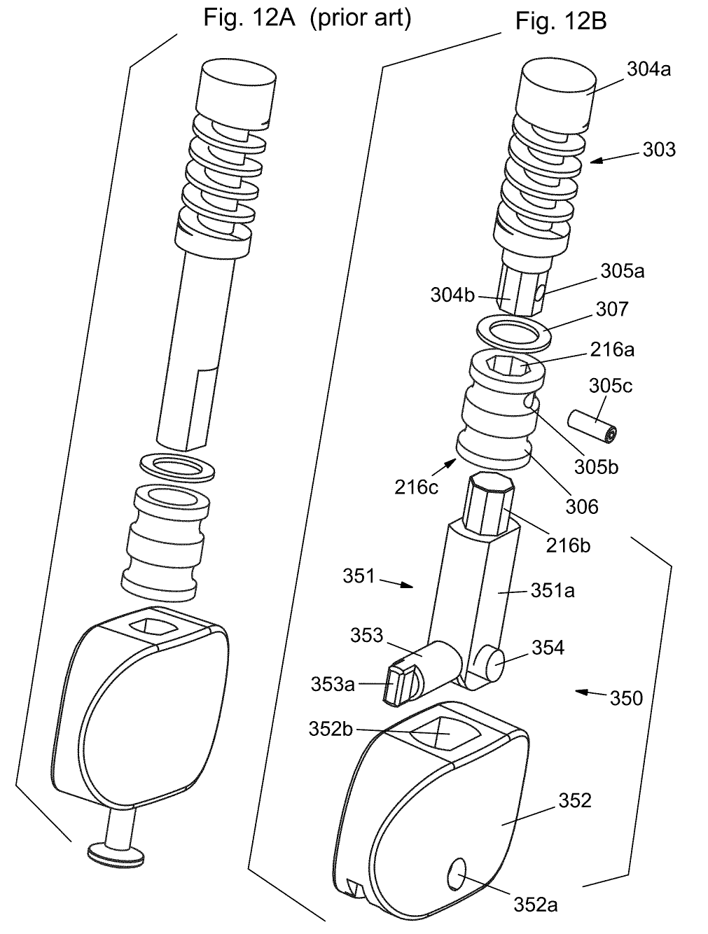

Worm 303 of FIG. 11B, 12B, is rotatably affixed on mounting plate 300 and cooperates with worm gear 323. Plug end 304a cooperates with mounting plate 300, and the other end has tuning socket driver 304b which has a transverse threaded hole 305a. Collar 306, with tuning sockets 216a at both ends, is affixed to tuning socket driver 304b by set screw 305c, which cooperates with hole 305b in collar 306 and threaded hole 305a of tuning socket driver 304b. I presently anticipate worm 303 and collar 306 to be made of steel, but other materials could be used.

Button 352 of FIG. 14C has an ergonomic shape with smooth curves and is of traditional appearance, and has a cavity 352b which cooperates with body 351a and screwdriver 353 of driver 351. Button 352 has a threaded hole 352a. I anticipate at present for this embodiment, the use of plastic for a construction material, but other materials such as wood, mother of pearl, stone, steel, aluminum or brass could be utilized.

Button-driver 351 of FIG. 14C has a screwdriver 353, which extends and retracts, and a fixed tuning socket driver 216b which is magnetized. Button 352 has a cavity 352b which cooperates with body 351a of driver 351 and screwdriver 353 in contracted position. Button 352 has a threaded hole 352a which threadedly engages with threaded end 354b of threaded pin 354. An assembly of button 352 and driver 351 is called button-driver 350.

One end of driver 351 terminates in a tuning socket driver 216b and the other end has a clevis 351d having two transverse holes 351c and a stop 351e. Screwdriver 353 has a blade 353a at one end which cooperates with slot 331f of string clamp 331a. The other end of screwdriver 353 has a yoke 353c which cooperates with clevis 351d. Screwdriver 353 has shoulder stop 353f that cooperates with stop 351e of clevis 351d when screwdriver is in extended position. Axel 354 has a threaded end 354b which threadedly engages with threaded hole 352a of button 352. Yoke 353c of screwdriver 353 pivots around axel 354, which has threaded end 354b cooperating with hole 352a, and secures driver 351 and screwdriver 353 to button 352. Currently, I contemplate for this embodiment, driver 351 to be crafted from steel, but other materials could be utilized. Button 352 and driver 351 could also be made from a single piece of material such as steel, plastic or brass. Screwdriver 353 could be machined in permanent extended position or it could be a separate retractable part having a cooperating cavity in the body of the button.

Disc string drum 344 has a disc drive 342a having an axial opening 335b of hexagonal profile 335a extending therethrough, which slidably cooperates with hex drum drive 335a of drum end 335. Disc drive 342a has an axial integral fixed disc 341 having a string hole 338b extending therethrough, to align with string hole 338a of hex drum drive 335a. A plurality of discs 342 have an axial hole 342b therethrough, which cooperate rotatably and slidably on both sides of fixed disc 341 on surface of disc drive 342a.

Shaft support 343, has a washer recess 337b, which cooperates with washer 337a and drum retainer screw 336b. Screw 336b and washer 337a cooperate with end threaded hole 336a to retain disc drum 344 to drum end 335. I presently anticipate for this embodiment, disc drum 344, discs 342, and string clamp 224 to be fabricated in steel, but other non-ferrous metals are suitable, and plastic is a possibility for discs 222.

Groove drum 345 has an axial opening extending therethrough, to slidably cooperate and be rotated by hex drum drive 335a of drum end 335 of drive shaft 331. String hole 338b (not shown) extends transversely therethrough, cooperating with string hole 338a of drum end 335. Groove drum 345 has an external helical groove comprising non-parallel groove walls that narrow together at a predetermined angle towards the axis of groove drum 345. At present, I contemplate for this embodiment, groove drum 345 to be constructed from aluminum, or a steel drum which is vulcanized with a rubber surface, but other materials will be suitable.

Low friction drum 346 has an axial opening extending therethrough, to slidably cooperate and be rotated by hex drum drive 335a of drum end 335 of said drive shaft 331. String hole 338b extends transversely therethrough, cooperating with string hole 338a of drum end 335. Low friction drum 346 has a string surface with reduced resistance to string 98. At present I envisage for this embodiment, low friction drum 346 to be constructed from a solid piece of ceramic with a polished finish, or a steel drum, or other material, with a surface coating of polished ceramic. I presently contemplate for this embodiment, another material that could be utilized is fiber and carbon impregnated PTFE.

### Operation of the Fourth Embodiment

Referring to FIG. 13A, B, rotating worm 303 urges worm gear 323 to rotate, but worm gear 323 cannot urge worm 303 to rotate. When worm gear 323 is rotated, pawl drive 326 is urged to rotate by keys 324a of worm gear 323 cooperating with keyways 324b of pawl drive 326. Integral drive ring 328 rotates pawls 329 positioned in pawl pockets 330. Teeth 329a urge internal teeth of ratchet 333 of ratchet drum 334 to rotate driveshaft 331, which resists rotation of driveshaft 331 in the opposite direction of rotation, thereby maintaining tension on string 98.

When torque is applied in one direction directly on driveshaft 331, teeth 329a of pawls 329 ride up run 333b of teeth 333a of ratchet 333 and then fall at rise 333c to another run 333b, thereby permitting rotation and course tuning of string 98.

Conversely, when torque is applied directly to driveshaft 331 in the opposite direction of rotation, teeth 333a of driveshaft 331, are held from rotation by teeth 329a of pawls 329 in pockets 330 of drive ring 328 of pawl drive 326. Teeth of worm gear 323 cooperating with worm 303 are held from rotation, thereby not permitting rotation of driveshaft 331.

Tuning socket driver 216b is magnetized to keep button-driver 350 secure to tuning socket 216a, but permits easy removal and replacement.

### Disc Driver

Referring to FIG. 14A, 11B, 15A, B, disc drum 344 increases tension equalization in string 98 which wraps around drum surface 344a. Driveshaft 331 is rotated and hex drum drive 335a urges hex socket 335b of disc drum 344 to rotate, and string 98 to wrap around discs 342. Tension equalization urges discs 342 to rotate independently of each other and cylinder surface 342a of disc drum 340, thereby increasing tension equalization of the string length that is wrapped around disc drum 344. By encouraging slippage of string 98, rather than resisting it, the low friction coefficient rapidly equalizes the tension of the section of string 98 around drum 226, thereby achieving stable tune quickly.

Groove drum 345 reduces tension equalization in string 98 which wraps around drum surface 345a. An increase in tension urges string 98 to deform and wedge deeper into the groove of drum surface 345a, thereby increasing friction and grip. Increase in tension of string 98 also results in a decrease in the diameter of string 98, and thereby wedges string 98 deeper into the groove of drum surface 345a. Groove drum 345 resists tension equalization with a high friction coefficient, rather than encouraging it, thereby achieving stable tune.

High friction drum 346 reduces tension equalization in string 98 which wraps around drum surface 346a, by resisting tension equalization with a high friction coefficient, rather than encouraging it, and thereby achieving stable tune.

### Button-Driver

Button-driver 350 of FIG. 11B, 12B, 14C, is disengaged from tuning socket 216a of worm 303, and screwdriver 353 is extended from cavity 353b of button 352. Stop 353f of screwdriver 353 cooperates with stop 351e of clevis 351d, thereby preventing over extension. Blade 353a and slot 331f, and surface 353b and head bore 331d cooperate with each other. Head bore 331d supports and aligns surface 353b during string clamping operation, whereby positioning of blade 353a in slot 331f is facilitated. Button-driver 350 is the only tool required to perform all functions of embodiment of FIG. 11B. String 98 replacement and tuning is rapidly accomplished.

### String Clamping

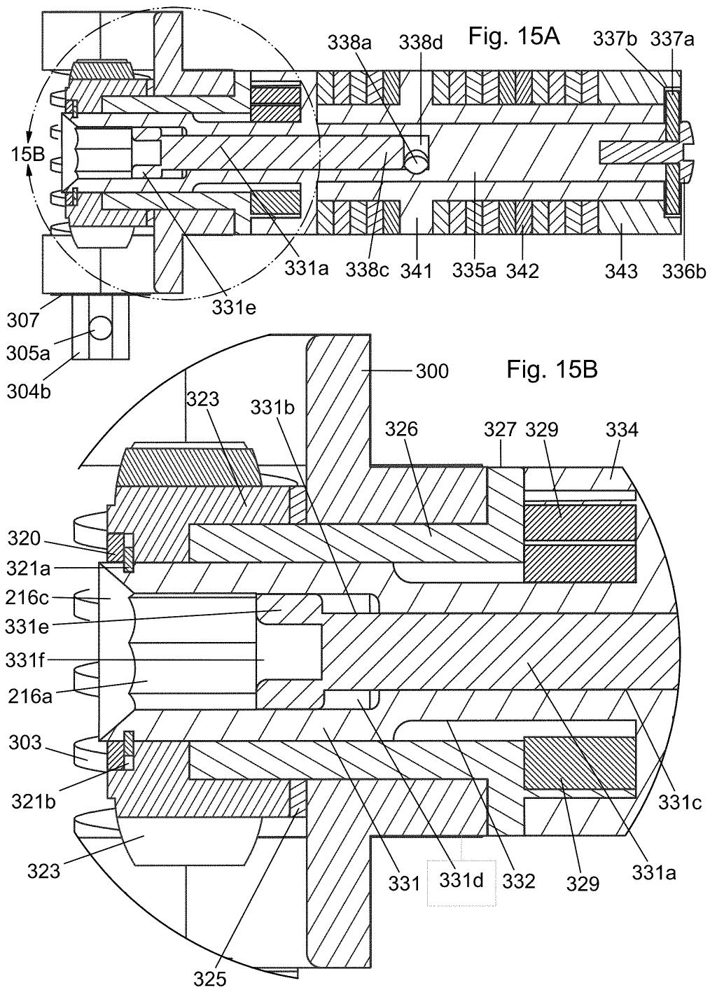

String clamp 331a has a pestle 338c with a polished surface and a round-over on its edge to prevent string 98 fracture during rotation. Mortar 338d has a frictional surface to increase grip on string 98 as pressure is increase on the string 98 as pestle 338c rotates during clamping. End of string 98 is inserted into string hole 338a and 338b (FIG. 15A) and pulled taut if string 98 is secured at other end. Extend and engage screwdriver 353 of button 352 in slot 331f of string clamp 331a and tighten appropriately. Other cooperating screwdrivers may also be used.

### Course Tuning Method 1

Tuning socket driver 216b of button-driver 350 is engaged in tuning socket 216a of driven end 322 of driveshaft 331. Button-driver 350 is rotated to course tune string 98 appropriately. Button-driver 350 is disengaged from tuning socket 216a of driveshaft 331 and engaged in tuning socket 216a of worm 303, whereby conventional fine tuning can commence. In summary, engage button-driver 350 to driveshaft to course tune.

### Course Tuning and Fine Tuning Method 2

A digital torque screwdriver has a tuning socket driver 216b installed in its chuck, and has been set to an appropriate torque for course tuning. Torque screwdriver is engaged in tuning socket 216a of driven end 322 of driveshaft 331. Torque is applied and then digital torque screwdriver is disengaged from tuning socket 216a. In summary, engage torque screwdriver to driveshaft to course tune.

As described, string 98 can be rapidly secured, course tuned manually and using a digital torque screwdriver, and fine-tuned conventionally. The tuner of embodiment of FIG. 11B eliminates tension equalization derived from knots, reduces tension equalization of strings tensioned around drums, reduces the protracted time in string replacement, and is housed in an enclosure of traditional dimension, mounting and appearance.

### Description of the Fifth Embodiment

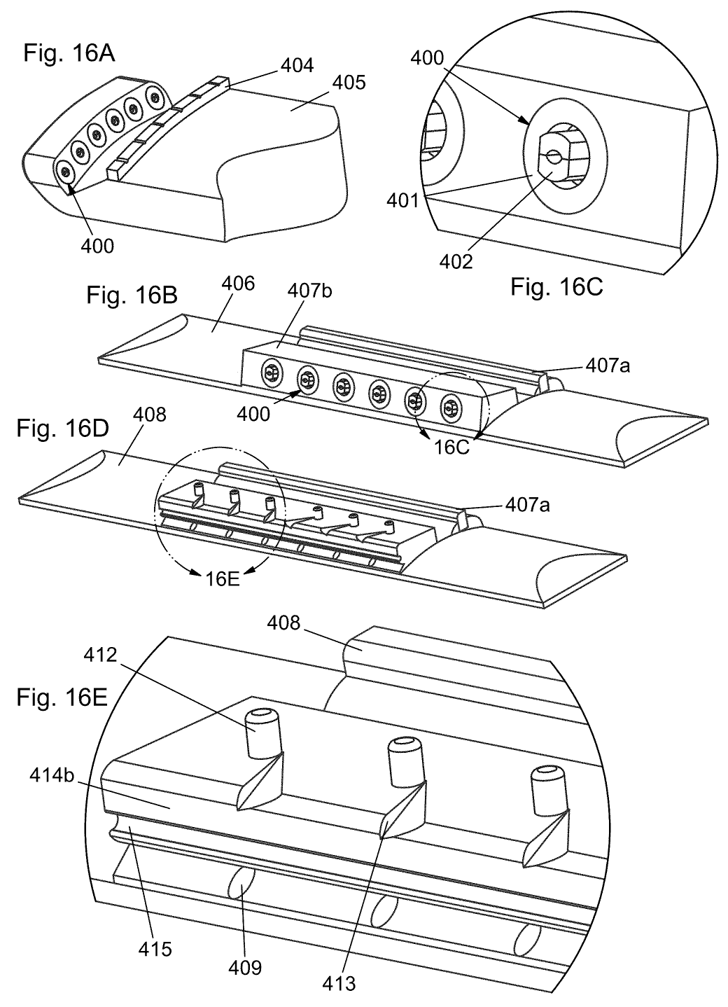

Speed clamp 400 of FIG. 16B, C, 17A, C, has a one-piece housing 401 to be fixedly disposed on an electric or an acoustic bridge 406, an instrument tailpiece, an instrument body, or a headless end stock 405. I presently contemplate housing 401 to be inserted into wooden structures such as bridges, tailpieces and end-stocks, but body 401 may be substituted by machining chamber 122 directly into an instruments tailpiece, bridge or bridge/vibrato assembly.

Forward end of housing has a chamber 122 (FIG. 5B) which cooperates with jaws 402. Jaws 402 are identical to jaws 121 except for a protrusion 402a extending beyond rearward end of housing. Jaws 402 have trimmed surface 121d (not depicted) to permit installation into chamber 122. Jaws 402 are retained in position by a retainer 138b cooperating with an internal radial groove 138c in front of housing 401. I presently contemplate jaws 402 to be fabricated from steel or a non-ferrous material, and housing 401 to be crafted in steel or aluminum. I currently anticipate for this embodiment, housing 401 to have a diameter of 6mm. Entrance of string hole 409 of bridge 406 is a smooth curve (not depicted) which increases tension equalization.

### Operation of the Fifth Embodiment

### String Replacement Method 1

Referring to FIG. 16B, 17C, end of string 98 is inserted between jaws 402 in forward end of housing 401 and flushed with end of protrusions 402a by human finger, without cutting string 98. Then human finger urges protrusions 402a forward, thereby urging string gripping surfaces 121f of jaws 402 and string 98 forward and together in chamber 122, thereby gripping string 98. In summary, insert string 98 and push forward with finger.

### String Replacement Method 2

End of string 98 is inserted between jaws 402 in forward end of housing 401 and therethrough, exiting protrusions 402a of jaws 402. End of string 98 is pulled rearward, manually or by a tensioning device, to course tune string 98, wherein jaws 402 do not grip string 98, as string 98 slides along jaws 402. Before pulling tension is released, a human finger urges string gripping surfaces 121f of jaws 402 forward and together in chamber 122 if necessary, thereby gripping string 98 and maintaining tension. In summary, insert string 98 and pull end of string 98 to course tune.

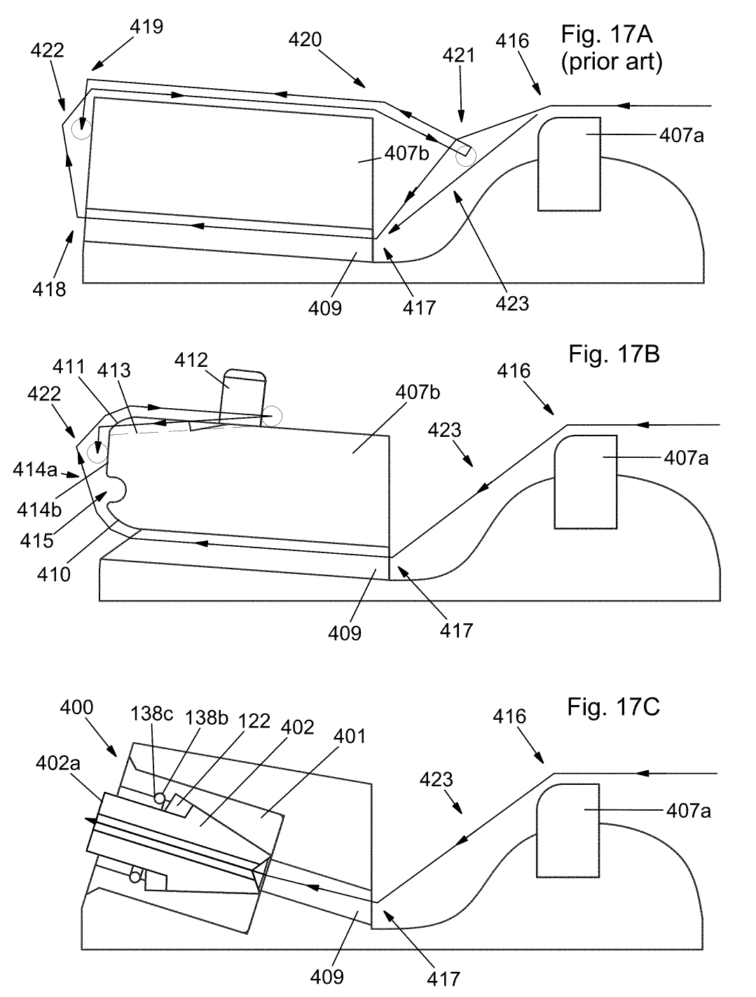

Referring to FIG. 17C, string 98 spans distance 423, in a straight path between saddle 407a and the entrance to string hole 409 as compared to prior art (FIG. 17A). The increased angle 416 over saddle 407a, increases saddle 407a down force as compared to prior art, thereby increasing volume and efficiency of instrument. Smooth curve (not depicted) of entry of string hole 417 increases tension equalization.

String 98 can be rapidly inserted and affixed, course tuned manually and using a tensioning device, all without the problem of tension equalization in string affixing knots. Size of speed clamp 400 permits a bridge of near traditional appearance, construction and dimension, and headless end-stock 405 (FIG. 16A) without need for metal attachment configurations, thereby permitting artistic freedom to the luthier.

### Description of the Sixth Embodiment

A traditional bridge of FIG. 17A, having a saddle 407a, a string hole 409, and a tie block 407b, but with the following modifications. Referring to FIG. 16D, E, 17A, B, tie block 407b has a curve of lower transition 410, a curve of upper transition 411 and reversal member 412. Entrance of string hole 409 is a smooth curve (not depicted) which increases tension equalization. Tie-block 407b has string stop 413. Front surface 414a has a string clearance slot 415 and above it a clamping surface 414b. I presently contemplate for this embodiment, bridge of FIG. 16D, to be crafted in rosewood or ebony, but many wood varieties or composite materials may be substituted. I currently anticipate for this embodiment, reversal member to be of diameter 2.3 mm and be crafted of rosewood, ebony, or brass, but other materials and sizes could be utilized.

### Operation of the Sixth Embodiment

Referring to FIG. 16D, E, 17A, B, tie block 407b has a curve of lower transition 410, and a curve of upper transition 411 which increases tension equalization around these sharp bends. String reversal member 412, removes string 98 length from behind the saddle 407a, thereby reducing tension equalization, and sharp bend 420 (FIG. 17A) is avoided, eliminating a source of tension equalization. The string reversal member 412 relieves string 98 serving as a string reversal point 421, and removes the sharp bend around string 98, thereby eliminating a source of tension equalization. String 98 spans the distance 423, in a straight path between saddle 407a and the entrance to string hole 409. The increased angle 416 over saddle 407a increases saddle 407a down force on as compared to prior art (FIG. 17A), thereby increasing volume and efficiency of instrument.

String clearance slot 415 permits end of string 98 to be easily placed under previous wrap of string 98, avoiding the difficulties of prior art, where tension of string 98 must be released to permit end of string 98 to be positioned under string 98. String stop 413 permits pulling end of string 98 without regards to pulling too far. In prior art, string 98 is pulled cautiously to avoid pulling too far, which bumps string up onto top of tie-block 407b wherein no clamping results.

Front surface 414a has a clamping surface 414b positioned high up on tie-block 407b, which increases the angle of string 98 at clamping point 422, thereby increasing grip of string 98. This high position is possible due to string stop 413, permitting increased tension to be applied to string 98 without bumping up to top surface of tie-block 407b.

String 98 lays over saddle 407a, and is fed through string hole 409, and then wraps over curve of lower transition 410. String 98 continues upward on front surface 414a to wrap over upper transition 411, and on to string reversal member 412. String 98 is pre-tensioned by hand, and tension of string 98 is held by a human finger until string 98 is clamped. String 98 is fed into the string clearance slot 415 and under string 98 which was previously wrapped around front surface 414a. End of string 98 is pulled by hand in a direction parallel to string clearance slot 415. This tension urges end of string 98 to contact string stop 413, and then urges end of string 98 out of string clearance slot 415, under string 98, and on to clamping surface 414b, thereby being clamped.

String 98 can be quickly replaced and pre-tensioned to a predetermined amount without reducing saddle 407 downforce. The reduced string length behind saddle 407, and the rounded edges of transitions 410, 411 and 417, increase tension equalization. The bypassing of transitions 420 and 421 eliminates possible tension equalization from these points. All of the advantages aforementioned in bridge 408 of near traditional appearance, construction and dimension.

### Advantages

From the description above, a number of advantages of some of my embodiments become evident:
a) Embodiments of tuners, bridges, and an end-stock, present a practical solution to the problem of tension equalization and the protracted time of string replacement and course tuning. These solutions permit large excursions in string bending, vibrato, and vibrato arm use with greater success in returning to pitch. Instruments correspondingly, maintain their relative pitch to a much higher degree during temperature and humidity changes.
b) Both linear tuner embodiments employ course tuning to solve the sever problem of limited piston travel.
c) Course tuning is utilized in all embodiments to reduce the protracted time in string replacement.
d) Both linear tuner embodiments solve the problem of excessive fine tuning ratios, as demonstrated in previous art in the range of 40:1, by employing customary ratios.
e) Some previous art linear tuners use rigid bearing surfaces to transition the string into the tuner, thereby introducing the problem of tension equalization, which is avoided by using a pulley to transition the string.
f) Both linear tuner embodiments are free of gear backlash, which requires tuning from below the note.
g) Both linear tuner embodiments use a light weight and easy to fabricate peg heads. This simplifies the tuning of an instrument due to the ergonomic positioning of the buttons beneath the headstock, which permit line of sight and an ergonomic hand position.
h) All course tuning embodiments can be course tuned without additional tools, by applying your hand or utilizing the self-contained button-driver.
i) The removable button-driver, an element of some embodiments, is ergonomic in shape and size and permits torque to be applied nearly effortlessly during string clamping and course tuning. Some previous art examples suffer from undersized knobs, which in practice require a pair of pliers or other tools, as they are difficult or impossible to rotate by hand.
j) Some embodiments, possessing automatic string clamping and releasing, permit string removal and replacement to be accomplished in seconds.
k) All embodiments permit easy and inexpensive installation to a stringed musical instrument by having traditional size, shape, appearance, and utilizing industry customary mounting. Some embodiments have enclosures utilizing the dimensions of prior art, thereby permitting retro-fitting into existing instruments, and installation into new factory production without any modifications.
l) Large, heavy and complex classical guitar headstocks (Torres), which are expensive to fabricate, are replaced with a traditional peg head having linear tuner embodiments using a single 8 mm mounting hole per tuner.
m) The end-stock embodiment permits a luthier's artistic license to be expressed in the most prized position. Prior art end-stock termination devices add weight and require neck terminations of predetermined shape and size.
n) Embodiments enabling tensioning or torque devices, replace the need for built in electro/mechanical devices, and course tuning obliterates the need for peg winders.

### Conclusions, Ramifications and Scope

Thus the reader will see that at least some embodiments eliminate tension equalization derived from knots, diminish tension equalization of strings tensioned around drums, permit rapid and/or automatic string affixing and releasing, rapid manual course tuning, rapid course tuning using a tensioning device or torque device, and conventional fine tuning, with all embodiments having traditional appearance, size, and mounting.

Many other variations are possible. For example, the use of two jaws 121 per chamber 122 in embodiment of FIGS. 1A and 2A, B, can also be reduced to a single jaw 121 having a cooperating chamber 122, incorporating an axial string gripping surface 121f.

Also, pulley 103 in capstan 102 and 102a of FIG. 4B, could be replaced with a substantially smooth curved bearing surface at a predetermined position and size to facilitate the bending of string 98 as it enters string hole 111 and 111a.

Cam 114 could be cut flush transversely to the axis and threaded to cooperate with axial hole 119b of capstan 102, thereby urging release actuator 119a rearward. Release actuator 119a would have a modified cooperating surface with modified cam 114. Further, selector knob 100 could have skirt 101 threadedly engaging neck 102, and utilizing above cam modification.

Referring to FIG. 4B, 5B, set screw 107a, set screw recess 107b and centering hole 107c could be omitted to save manufacturing costs with centering being done by feel and having a frictional thread fit or utilizing a commercially available thread lock adhesive.

Further, capstan 102 of FIG. 4B, 5B, could be secured to neck 112 of cylinder 150 by axial aligned screws, with cooperating holes, through capstan 102 to neck 112, or via transverse screws or drift pins with cooperating holes, through capstan 102 into cylinder 150.

Cylinder plunger 124 and piston plunger 135 could be crafted in plastic and utilize a magnet (possibly a magnetic washer) positioned appropriately to replace the function of springs 133 and 139. Jaws 121 may need to be fabricated in a non-ferrous metal or other material such as plastic. The magnet may require a predetermined distance from ferrous metal bevel 125c for proper operation.

String clamp 224 could be removed and string drum 226, 227 and 228 could have a tuning socket 216a which cooperates with button-driver 237 or 350, permitting course tuning to be accomplished at both ends of driveshaft 214. A string clamp threadedly engages threaded hole 223a, and has pestle 225b at one end which cooperates with mortar 225a. At the other end of the string clamp is a slot which cooperates with blade 353a of screwdriver 353. The string clamp when tightened is flush with forward end of drum end 219. Disc drum 229 could utilize the new string clamp wherein discs 222 are retained by a nut that threadedly engages with an extended drum end 219.

String clamp 331a could be replaced with chamber 122, being machined into a modified hex drum drive 335a which cooperates with modified string drums 344, 345, 346 and 347. Jaws 402 or 121 could be utilized, or modified versions. A plunger, a spring and a retainer is also a possibility.

The speed clamp 400 of FIG. 17C could have jaws 402 urged forward by a spring and plunger, or utilize a magnet as described above. Chamber 401 could have an axial string gripping surface 121f which would permit using one jaw 402. Protrusion 402a could also be removed and be replaced with a flat flush surface, or having another shape or size.

Low friction drum 347 of FIG. 11B, (not shown) increases tension equalization in string 98 which wraps around drum surface 347a. By encouraging slippage of string 98, rather than resisting it, the low friction coefficient rapidly equalizes the tension of the string section around drum 347, thereby achieving stable tune quickly.

Tie-block 407b of FIGS. 16B and D, could be moved forward to the saddle 407a to reduce length of string 98 behind the saddle. Slots or holes cut into the tie-block would clear the string path from saddle to string hole 409.

I presently contemplate using key 119c cooperating with keyway 119d, but non symmetrical shapes could also be used for release actuator 119a, thereby negating the need for a key and possibly lowering manufacturing costs.

While my above description contains many specificities, these should not be construed as limitations on the scope, but rather as an exemplification of several embodiments thereof. Accordingly, the scope should be determined not by the embodiments illustrated, but by the appended claims and their legal equivalents.

What is claimed is:

1. A tuner for stringed musical instruments possessing a practical solution to the problem of tension equalization and the protracted time of string replacement and tuning comprising:
a generally tube cylinder, with forward end having an integral capstan, is adapted to be fixedly disposed in an opening in the peg head of a stringed musical instrument by a nut cooperating with an external threaded shoulder of said capstan of predetermined position and thread form, and said cylinder having threads rearward which cooperate with a nut, wherein various thicknesses of a peg head are accommodated, and said capstan having an axial string hole therethrough, and having a string clearance slot of predetermined size projecting outwardly from said axis, and having a first means to guide a string into said string hole, and having at least one axially aligned keyway in the internal wall of said cylinder, and having a first means to secure a generally cylindrical piston to said cylinder,
and said piston is slidably disposed in said cylinder, and having a key projecting into said keyway of said cylinder, whereby said piston can translate in said cylinder and is held against rotation, and said piston having an external thread of predetermined thread form, and the forward end of said piston having a chamber with openings forward and rearward therethrough of a predetermined size, and said chamber having two, first offset inclined surfaces relative to the axis, whereof said first offset inclined surfaces of said chamber commences at the forward opening, and ends at an inside wall of said cylinder,
and a jaw having an axially aligned string gripping surface, and having a second offset inclined surface to be slidably disposed and cooperate with said first offset inclined surface of said chamber, and forward end of said jaw having a first surface of a predetermined angle, and rearward end of said jaws having a second surface of a predetermined angle, and said chamber having two said jaws,
a slidably disposed piston plunger, having an axial string hole therethrough of a predetermined size, to permit passage of said string, cooperates inside of said piston, and forward end of said piston plunger having a third surface of predetermined angle that cooperates with said second surfaces of said jaws, and said piston plunger, having a second means to be held forward, urges said jaws forward, and said first offset inclined surfaces urge said jaws together, thereby placing said jaws in closed position,
a button having a threaded hole axially therethrough, threadedly engages with said external threads of said piston, and said button being supported for rotation by a drive surface relative to a driven surface of said cylinder, but being held against forward longitudinal movement relative thereto, and having a third means to be affixed to said piston,
and said string is inserted into said string hole of said capstan and therethrough, exiting rearward end of said button, then said string exiting said button, may be pulled rearward manually or by a tensioning device to increase string tension, thereby course tuning said string, wherein said jaws do not grip as said string slides along surface of said jaws, and when pulling tension is released, said jaws grip said string, thereby maintaining increased string tension, and one or more course tunings may be repeated, and to commence fine tuning, rotate said button,
whereby said string can be rapidly inserted and automatically affixed, course tuned manually, course tuned by said tensioning device, and fine-tuned conventionally by rotating said button, while eliminating tension equalization derived from securing knots and drums, reducing the protracted time in replacement of said string, and having traditional dimension, mounting and appearance.

2. The solution of claim 1 wherein rearward end of said capstan having a release stub with an axially located string hole, and rearward end of said release stub having a forth surface, cooperating with said first surface of said jaws,
and said button is rotated and/or spun to rearward end of said piston, and then said piston is translated forward until said drive surface of said button contacts said driven surface of said cylinder to a release position, whereby said forth surface of said release stub urges said jaws apart, and said piston plunger, urged by said second means, also urge said jaws apart to said open position, and said string is inserted into said string hole of said capstan and therethrough with said string exiting the rearward end of said button, whereby said string replacement is facilitated by said jaws being in said open position,

3. A tuner for stringed musical instruments possessing a practical solution to the problem of tension equalization and the protracted time of string replacement and tuning comprising:
a generally stub capstan adapted to be fixedly disposed in an opening in a peg head of a stringed musical instrument by a first nut cooperating with an external threaded shoulder on said capstan of predetermined position and thread form, and having an axial opening extending therethrough of predetermined size comprising an axially aligned first keyway in the sidewall, and having a first string clearance slot of predetermined size projecting outwardly from axis of said axial opening, and having a first means to guide a string into said axial opening, and said capstan is secured to a said cylinder by a second means,
a slidably disposed, generally cylindrical release actuator, having an axial string hole extending therethrough of predetermined size, and said release actuator cooperates with said axial opening and having a first key that cooperates with said first keyway, and rearward end of said release actuator having a first surface of predetermined angle, and having a second string clearance slot of predetermined size, situated forward of said first surface, projecting outwardly from said axis of said axial hole, which cooperates with said first and second string clearance slots, thereby creating clearance for said string and said first means to guide a string into said axial opening, and said release actuator having a third means to be translated,
and a selector knob, having a forth means to station at a home position and a pull position, and having said third means to translate said release actuator, and having a fifth means to be affixed to said capstan,
a generally tube cylinder is adapted to be fixedly disposed in said opening in said peg head of said stringed musical instrument, and said cylinder having threads cooperating with a second nut, wherein various thicknesses of said peg head are accommodated, and having at least one axially aligned second keyway in the internal wall of said cylinder, and having a sixth means to secure a generally cylindrical piston to said cylinder,
and the forward end of said cylinder having a chamber with openings forward and rearward therethrough of a predetermined size, and said chamber having two, first offset inclined surfaces relative to the axis, whereof said first offset inclined surfaces of said chamber commences at the forward opening, and ends at an inside wall of said cylinder,
a slidably disposed cylinder plunger cooperates inside said cylinder, and having an axial string hole therethrough of a predetermined size to permit passage of said string, and forward end of said cylinder plunger having a forth surface of a predetermined angle that cooperates with said third surface of said jaws, and said cylinder plunger having a seventh means to be urged forward, urges said jaws of said cylinder forward and together, thereby placing said jaws in said closed position, and rearward end of said cylinder plunger having a fifth surface of a predetermined angle,
and a jaw having an axially aligned string gripping surface, and having a second offset inclined surface to be slidably disposed and cooperate with said first offset inclined surface of said chamber, and forward end of said jaw having a second surface of a predetermined angle which cooperate with said first surface and said fifth surface, and rearward end of said jaw having a third surface of a predetermined angle, and said chamber having two said jaws,
and said piston is slidably disposed in said cylinder, and having a second key projecting into said second keyway of said cylinder, and said piston can translate in said cylinder and is held against rotation, and said piston having an external thread of predetermined thread form, and the forward end of said piston having said chamber, and said chamber of said piston having two said jaws,
a slidably disposed piston plunger, having an axial string hole therethrough of a predetermined size to permit passage of said string and cooperates with inside of said piston, and forward end of said piston plunger having a sixth surface of predetermined angle that cooperates with said second surface of said jaws, and said piston plunger, having an eighth means to be held forward, urges said jaws of said piston chamber forward and together, thereby placing said jaws in said closed position,
a button having a threaded hole axially therethrough, threadedly engages with external threads of said piston, and said button being supported for rotation by a drive surface relative to a driven surface of said cylinder, but being held against forward longitudinal movement relative thereto, and having a ninth means to be affixed to said piston,
and with said selector knob stationed in said pull position by said forth means, said jaws of said cylinder chamber are urged forward and together by said first offset inclined surfaces of said cylinder chamber and by said cylinder plunger by said seventh means to said closed position, and said jaws of said cylinder chamber urge said release actuator forward, and said button is rotated to rearward end of said piston and then rotated forward with predetermined revolutions, and then said piston is translated forward until said drive surface of said button contacts said driven surface of said cylinder to a retracted position, and said jaws of said piston are urged forward and together by said piston chamber and by said piston plunger, having said eighth means, to said closed position,
and with said selector knob stationed in said home position by said forth means, said release actuator is urged rearward by said third means and in turn urges said jaws of said cylinder chamber rearward and apart, and said jaws of said cylinder chamber urge said cylinder plunger rearward, while said cylinder plunger urges said jaws of said cylinder chamber apart, thereby positioning said jaws of said cylinder chamber in said open position,
and having said piston in said retracted position, said jaws of said piston chamber are urged forward and together by said first offset inclined surfaces of said piston chamber and by said piston plunger by said eighth means to said closed position,
and with said selector knob stationed in said home position by said forth means, said jaws of said cylinder chamber are in said open position, then said button is rotated and/or spun to rearward end of said piston, and then said piston is translated forward until said drive surface of said button contacts said driven surface of said cylinder to said release position, whereby said cylinder plunger by said seventh means urges said jaws of said piston apart, and said piston plunger, urged by said eighth means, also urges said jaws of said piston apart to said open position, and said string is inserted into said string hole of said selector knob and therethrough with said string exiting the rearward end of said button, whereby said string replacement and removal is facilitated by said jaws of said cylinder chamber and said piston chamber being in said open position,
utilizing course tuning method 1, having said selector knob stationed in said home position and having said piston in said release position, said string is inserted into said string hole of said selector knob and extended therethrough and having said string exiting said button, then said piston is translated to said retracted position and said selector knob is stationed in said pull position, wherein said jaws of said cylinder chamber are in said closed position and said jaws of said piston chamber are in said closed position,
then said button is pulled rearward, urging said jaws of said piston chamber to grip said string, and said jaws of said cylinder chamber in said closed position, do not grip as said string slides along surface of said jaws of said cylinder chamber, and when pulling tension is released, said jaws of said cylinder chamber grip said string, thereby maintaining increased string tension, and when said button is pushed forward, said jaws of said piston chamber do not grip said string, as said jaws of said piston chamber slide along surface of said string, whereby one or more course tunings may be repeated,
and to commence fine tuning, rotate said button with predetermined revolutions to transfer string tension from said jaws of said cylinder chamber to said jaws of said piston chamber, and then rotate said selector knob to said home position, and then rotate said button to fine tune,
utilizing course tuning method 2, having said selector knob stationed in said home position and having said piston in said release position, said string is inserted in said string hole of said selector knob and extended therethrough and having said string exiting said button, then said piston is translated to said retracted position and said selector knob is stationed in said pull position, wherein said jaws of said cylinder chamber and said piston chamber are in closed position,
then said button is rotated, urging said piston rearward, and thereby urging said jaws of said piston chamber to grip said string, and said jaws of said cylinder chamber in said closed position, do not grip as said string slides along the surface of said jaws of said cylinder chamber, and when pulling tension is released, said jaws of said cylinder chamber grip said string, thereby maintaining increased string tension, then said piston is translated to said retracted position, whereby said jaws of said piston do not grip said string as said jaws of said piston chamber slides along surface of said string, whereby one or more course tuning may be repeated if desired,
to commence fine tuning, rotate said button forward with predetermined revolutions to transfer string tension from jaws of said cylinder chamber to jaws of said piston chamber, and then rotate selector knob to home position, and then rotate said button to fine tune,
utilizing fine and course tuning method 3, having said selector knob stationed in said home position and having said piston in said release position, said string is inserted in said string hole of said selector knob and extended therethrough and having said string exiting said button, rotate said selector knob to said pull position wherein said jaws of said cylinder chamber are in said closed position,
then said string exiting said button is pulled manually or by a tensioning device rearward, to increase string tension, wherein said jaws of said cylinder chamber do not grip as they slide along surface of said string, and when pulling tension is released, said jaws of said cylinder chamber grip said string, thereby maintaining increased string tension, and one or more course tunings may be repeated,
to commence fine tuning, translate said piston to said retracted position and rotate said button forward with predetermined revolutions to transfer string tension from said jaws of said cylinder chamber to jaws of said piston, and then rotate selector knob to home position, then rotate said button to fine tune,
utilizing fine tuning method 4, having said selector knob stationed in said home position and having said piston in said release position, said string is inserted in said string hole of said selector knob and extended therethrough and having said string exiting said button, then rotate said button to urge said piston rearward, thereby urging said jaws of said piston to grip and fine tune said string, and said cylinder jaws in said open position do not grip said string, thereby permitting said string to be tensioned conventionally by rotating the button,
whereby said string can be rapidly inserted and automatically affixed, course tuned manually, course tuned by said tensioning device, and fine-tuned conventionally by rotating said button, while eliminating tension equalization derived from securing knots and drums, and having traditional dimension, mounting and appearance.

4. The solution to claim 3 wherein first means is a pulley of predetermined size, shape, and position which cooperates with said second and third string clearance slots, and said pulley is affixed with an axel having a threaded end that cooperates with a threaded hole in said capstan, and said pulley having a string groove of predetermined size, position and profile on the radial surface, whereby tension equalization is increased and profile distortion of said string is reduced.

5. The solution to claim 3 wherein second means is said cylinder having a threaded neck which threadedly engages with an internal thread of a rearward socket in said capstan, and said capstan having a set screw of predetermined size and position threadedly engaging a transverse hole in sidewall of said capstan therethrough, which cooperates with a set screw recess of predetermined size and position in said cylinder neck, whereby attachment and alignment of said capstan to said cylinder neck is realized and maintained.

6. The solution to claim 3 wherein third means is said selector knob having a rearward axial cam shaft of predetermined size, and having a cam surface at rearward end that cooperates with a cam surface on forward end of said release actuator, and an axially located string hole therethrough of predetermined size, and a third string clearance slot of predetermined size projecting outwardly from axis of said axial located string hole, and said cam shaft having a first surface stop that cooperates with a second surface stop of said release actuator,
and said forth means is said selector knob having a first knob stop that cooperate with a second knob stop on said capstan, which stations said selector knob and said release actuator at said home position, and said selector knob having a third knob stop that cooperate with a forth knob stop on said capstan, which stations said selector knob and said release actuator at said pull position, whereby rotation of said selector knob stations said release actuator at said home position and said pull position, whereby different modes of operation can be rapidly selected.

7. The solution to claim 3 wherein fifth means is a skirt that cooperates with a capstan neck at the forward end of said capstan, and said skirt having a bevel of predetermined angle and size on the inside rearward edge, and said skirt having a groove of predetermined size, depth and position which cooperates with a split ring wire retainer which cooperates with a groove in said capstan neck,
whereby said split ring wire retainer, positioned in said groove of said capstan neck, is compressed flush to surface of said capstan neck by said bevel and said skirt as said selector knob is pressed onto said capstan neck, and said split ring wire retainer expands in groove of said skirt when fully deployed, thereby securing said selector knob to said capstan, whereby the retention of said selector knob to said capstan is hidden, secure from consumer tampering, and facilitates ease of assembly and manufacturing.

8. The solution to claim 3 wherein said sixth means is said cylinder having one or more threaded holes cooperating with one or more set screws, which cooperate with said second key of said piston and said second keyway of said cylinder, and said threaded holes are positioned at the furthest point of translation of said second key of said piston, and said threaded holes of said cylinder traverse said second keyway transversely and being tangently flush to the inside surface of said cylinder, whereby a positive stop to said piston translation results, and removal of said set screws permits assembly and disassembly of said piston to and from said cylinder.

9. The solution to claim 3 wherein said seventh means is two or more extension springs having each end terminated with a hook cooperating with a transverse drift pin at the vicinity of each end of a cooperating spring housing hole in said cylinder and said cylinder plunger, whereby volume of said cylinder is preserved with no loss of piston travel rearward of the cylinder plunger.

10. The solution to claim 3 wherein said eighth means is a compression spring retained by an externally threaded adjustable nut to cooperate with an internal thread of said piston, whereby precise pressure on said plunger can be adjusted to facilitate said tuning methods 1, 2 and 3, wherein said jaws of said piston chamber slide along surface of said string during translation of said piston to said retracted position.

11. The solution to claim 3 wherein said ninth means is a first radial groove in said threaded hole at the forward end of said button of predetermined size and position, to permit a cooperating split ring wire retainer to expand flush to surface of said threaded hole, and a second radial groove in said external thread at the rearward end of said piston of predetermined size, which is positioned to cooperate with said first radial groove at said release position, and said second radial groove having a bevel, of predetermined angle, from deepest point forward to surface of said piston,
and rotation of said button to rearward end of said piston, urges said split ring wire retainer to slide and contract on said bevel and seat in said second radial groove at said release position, thereby creating a positive stop and retaining said button to said piston, and upon forward rotation of said button, said split ring wire retainer slides and expands on said bevel to said surface of said threaded hole and slides on the surface of said external thread of said piston,
and installation of said split ring wire retainer into said button uses an expander tool and a stanchion tool, and said stanchion tool is generally a cylinder having a smooth surface which cooperates with said internal thread of said button, and having a means to be mounted to a work surface, and said cylinder of said stanchion having a seat at the opposite end of said means to be mounted,
and expander tool is generally a cylinder having a smooth surface which cooperates with said internal thread of said piston, and said expander tool having a cone that cooperates with said threaded hole of said button and said split ring wire retainer,
whereby button is axially aligned and positioned on said cylinder of said stanchion tool, and the retainer is positioned in said threaded hole of said button and sits on said seat, and expander tool is positioned having said cone axially aligned with said stanchion tool and making contact with the retainer, and said threaded hole of said piston is slid over said cylinder of said expander tool, and a downward force is applied to said piston, thereby urging said expander tool to expand the retainer into said groove of said button, and translating said button on said stanchion permits said downward force to continue to urge the retainer into said groove of said piston, and said button and said piston are translated for removal from said stanchion and said expander tool, whereby the retention system of the button to the piston is hidden, secure from consumer tampering, and facilitates ease of assembly and manufacturing.

12. The solution to claim 3 further comprising an alignment spring inside said cylinder, positioned between said piston and said cylinder plunger and having an axial opening of a predetermined size to align said string with axial center of said cylinder, whereby during said course tuning method 1, 2 and 3, said alignment spring expands and contracts with piston translation thereby preventing the string from bending or collapsing during retraction, and thereby freeing a hand from keeping said string taut.

13. The solution to claim 3 further comprising a first radial groove in forward end of said piston of predetermined size, to permit a cooperating split ring wire retainer to compress flush to the surface of said piston, and a second radial groove on the inside wall at the rearward end of said cylinder of predetermined size, is positioned to cooperate with said first radial groove at an extended position of said piston, and said second radial groove having a bevel, of predetermined angle, from deepest point forward to surface of said cylinder, whereby the retainer is compressed by said surface of said piston during translation in said cylinder, and expands on said bevel until fully expanded when seated in said second radial groove, thereby creating a positive stop and retaining said piston to said cylinder, and the retainer compresses again on reversal of translation, whereby retention of the piston to the cylinder is hidden, secure from consumer tampering, and facilitates ease of assembly and manufacturing.

14. The solution to claim 3 further comprising an adapter of predetermined size and shape, having a hole transversely therethrough, and having an alignment slot cooperating with an alignment tab of pre-determined size, position and shape on forward end of said cylinder, and said adapter is sandwiched between said cylinder and a said capstan and can be further retained by said capstan nut, and said adapter having a stub at a plate end with a threaded hole of predetermined size and thread form to cooperate with a fastener to affix said mounting plate to said adapter, and said stub having at least one key that cooperates with a hole having a keyway in a mounting plate, thereby resisting rotation, and said mounting plate having holes of predetermined size and position that cooperate with said fasteners for mounting to an instrument, whereby guitars having Torres style headstocks can be free of tension equalization derived from string affixing knots and drums at the headstock, and enable rapid string replacement and tuning.

15. A tuner for stringed musical instruments possessing a practical solution to the problem of tension equalization and the protracted time of string replacement and tuning comprising:
a driveshaft having an integral ratchet with a plurality of teeth of predetermined position and size, and terminates rearward with a driven end comprising a first means to be rotated, and terminates forward with a drum end having a second means to drive a string drum, and said drum end having an axial threaded hole of predetermined size and thread form and having a mortar at its base of predetermined shape and size, and a transverse first string hole therethrough at the base of said threaded hole, which cooperates with said mortar,
a worm gear with a plurality of teeth and an axial integral pawl driver drum, cooperating with said ratchet, having at least one pawl pocket cooperating with at least one pawl having at least one tooth, and having an axial driveshaft hole therethrough, is slidably and rotatably disposed on said driven end, and is sandwiched between said ratchet and retained by a third means, and an enclosure, to be fixedly disposed on a stringed musical instrument, is slidably and rotatably disposed on said drum end, and is sandwiched between said ratchet and is retained by a forth means, and said enclosure having a cover with an opening of predetermined size to cooperate with the diameter of said driven end of said drive shaft,
a string drum of predetermined size and shape cooperates with said second means, and having fifth means to alter tension equalization of a length of a string which is wrapped around said drum, and having a second string hole extending therethrough of predetermined position and size, to align with said first string hole of said drum end of said drive shaft,
and having a string clamp which threadedly engages with said threaded hole of said drum end, and forward end said string clamp having said first means to be rotated, and the other end having a pestle of predetermined shape, size and texture, cooperates with said mortar,
a worm is rotatably mounted and affixed in said enclosure and cooperates with said worm gear, and one end of said worm having said first means to be rotated, and a button-driver of predetermined shape and size having means to rotate said second means to be rotated,
rotating said worm urges said worm gear to rotate, but said worm gear cannot urge said worm to rotate, and when torque is applied directly in one direction to said driveshaft, a pawl tooth rides up a tooth run of said tooth of said ratchet and then drops off a tooth rise of said tooth of said ratchet to said tooth run of another said tooth of said ratchet, thereby permitting rotation of said driveshaft, and conversely, when torque is applied in the other direction directly to said driveshaft, said pawl tooth urges said tooth rise of said tooth of said ratchet to move, thereby rotating said driveshaft and said string drum,
and said string is inserted into said string holes, and said first means of said string clamp is rotated by said button-driver, whereby said pestle and said mortar clamp said string, and then said button-driver or a torque device is engaged in said first means of said driveshaft, and a predetermined tension is applied, then said button-driver or said torque device is disengaged from said first means of said driveshaft, and then said button-driver is engaged in first means of said worm, and rotated for conventional fine tuning,
whereby said string can be rapidly clamped, course tuned and fine-tuned conventionally by said button-driver, and course tuned by said torque device, thereby eliminating tension equalization derived from securing knots, reducing tension equalization derived from said drums, reducing the protracted time in replacement of said strings, and being housed in said enclosure of traditional dimension, mounting and appearance.

16. A tuner for stringed musical instruments possessing a practical solution to the problem of tension equalization and the protracted time of string replacement and tuning comprising:
a driveshaft having an integral ratchet drum having a plurality of internal teeth of predetermined position and size, and terminates rearward with a driven end comprising a first means to be rotated, and terminates forward with a drum end having a second means to rotate a string drum, and having a third means to secure said string drum to said drum end, and said drum end having a transverse first string hole at a predetermined position and size, and said driven end having an axial threaded hole terminating at said first string hole of predetermined size and thread form, and having a mortar at its base of predetermined shape and size which cooperates with said first string hole,
and a string clamp comprising at the rearward end, a threaded screw having a head with forth means to be driven, which threadedly engages with said axial threaded hole in said driven end, and the forward end of said threaded screw having a pestle which cooperates with said mortar,
a string drum of predetermined size and shape cooperates with said second means, and having fifth means to alter tension equalization of a length of a string which is wrapped around said drum, and having a second string hole extending therethrough of predetermined position and size, to align with said first string hole of said drum end of said drive shaft,
a worm gear having a plurality of teeth with sixth means to slidably engage and rotate a pawl drive having at least one pawl, and said worm gear and said pawl drive rotatably sandwiches a mounting plate, to be fixedly disposed on a stringed musical instrument, and said worm gear and said pawl drive having an axial hole extending therethrough, is slidably and rotatably disposed on said driven end of said driveshaft, and is affixed by a seventh means,
a worm is rotatably affixed on said mounting plate and cooperates with said worm gear, and one end having a eighth means to be rotated, and a collar with said first means to be rotated at both ends, is affixed to said eighth means to be rotated of said worm, and thereby secures said worm to said mounting plate,
and having a button-driver of predetermined shape and size which cooperates with said first means of said driveshaft and said collar, and having a tool which cooperates with said forth means of said head of said string clamp,
and when torque is applied in one direction on said driveshaft, a pawl tooth rides up a tooth run of said tooth of said ratchet and then drops off a tooth rise of said tooth of said ratchet to said tooth run of another said tooth of said ratchet, thereby permitting rotation, and conversely, when torque is applied in the other direction on said driveshaft, said pawl tooth urges said tooth rise of said tooth of said ratchet to move, thereby rotating said driveshaft, and said string wraps around said string drum, and when torque is applied to said button-driver which cooperates with said worm, said worm urges said worm gear to rotate,
and said string is inserted into said string holes and said forth means of said head of said string clamp is rotated by said tool of said button-driver, whereby said pestle and said mortar clap said string, and then said button or a torque device is engaged in said first means of said driveshaft and a predetermined tension is applied, then said button-driver or said torque device is disengaged from said first means of said driveshaft, and then said button-driver is engaged in first means of said worm, and rotated for conventional fine tuning,
whereby said string can be clamped, course tuned and fine-tuned conventionally by said button-driver, and course tuned by said torque device, while eliminating tension equalization derived from securing knots, reducing the problem of tension equalization derived from said drums, reducing the protracted time in replacement of said strings, and being housed in said enclosure of traditional dimension, mounting and appearance.

17. A bridge and a headless end-stock for stringed musical instruments possessing a practical solution to the problem of tension equalization, reduced saddle down force, and the protracted time in string replacement and tuning comprising:
a one piece housing to be fixedly disposed on a stringed musical instrument bridge, an instrument tailpiece, an instrument body, or a headless end stock, and said housing having an axial opening therethrough for a string to enter and exit, and the forward end of said housing having a chamber with connected openings forward and rearward of a predetermined size, and having two offset inclined surfaces relative to axis of said housing, whereof the said offset inclined surfaces commence at the forward end of said housing and at the farthest extent from the axis, ends at an interior wall of said housing,
and a jaw having an axially aligned string gripping surface and an offset inclined surface to be slidably disposed and cooperate with said surface of said chamber, and forward end of said jaw having a surface of a predetermined angle, and said jaw retained by a means, and said chamber having two said jaws,
utilizing installation method 1, end of a string is inserted into said forward end of said housing and flushed with end of said jaws by a human finger, and human finger urges said string gripping surfaces of said jaws towards the axis of said chamber, thereby gripping said string,
utilizing installation and course tuning method 2, end of said string is inserted into said forward end of said housing and therethrough exiting the rearward end of said jaws, whereby said end is pulled rearward, manually or by utilizing a torque device, to course tune, wherein said jaws of said housing do not grip as said string slides along surface of said jaws, and when pulling tension is released, said jaws of said housing grip said string, thereby maintaining string tension,
whereby a string can be rapidly inserted and affixed, course tuned manually and automatically by utilizing a torque device, all without the problem of tension equalization derived from said string affixing knots, no reduction of downforce on said saddle, having said bridge of near traditional appearance, construction and dimension, and said headless end-stock without need for metal attachment configurations.

18. A bridge for stringed musical instruments possessing a practical solution to the problem of tension equalization, reduced saddle down force, and the protracted time in string replacement comprising:
a traditional bridge having a saddle, a string hole, and a tie block, wherein said tie block having a string reversal member of a predetermined size and position, a string stop of predetermined position and size, a front surface having a string clearance slot of predetermined position and size, a clamping surface of predetermined position and size, and curves to transition a string around corners of said front surface and into said string hole,
a string lays over said saddle, and is fed through said string hole, and continues to wrap around said front surface to said string reversal member, whereby tension of a predetermined amount is applied by hand, and then said string direction is reversed, and tension of said string is held by a human finger, and said string having an end of predetermined length, is fed into said string clearance slot and under said string previously wrapped around said front surface, and said end of said string is pulled by a human hand in a direction parallel to said string clearance slot so that it urges said end of said string to contact said string stop, thereby urging said end of said string out of said string clearance slot and under said string and on to said clamping surface, thereby being clamped,
whereby a string can be quickly replaced and pre-tensioned to a predetermined amount without reducing downforce on said saddle, having reduced length of said string behind said saddle, and said curves increase tension equalization, and all with said bridge of traditional appearance, construction and dimension.
